(19) United States
(12) Patent Application Publication
(10) Pub. No.: US 2010/0306720 A1
(43) Pub. Date: Dec. 2, 2010

(54) Programmable Electrical Rule Checking

(76) Inventors: F. G. Pikus, Beaverton, OR (US); Ziyang Lu, Camas, WA (US); Philip Brooks, Tualatin, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/474,240

(22) Filed: May 28, 2009

(51) Int. Cl. G06F 17/50

(52) U.S. Cl. 716/5; 716/7

(57) ABSTRACT

Electrical rule checking techniques for analyzing integrated circuit design data to identify specified circuit element configurations. Both tools and methods implementing these techniques may be employed to identify circuit element configurations using both logical and physical layout information for the design data. A set of commands are provided that will allow a user to program a programmable electrical rule check tool to identify a wide variety of circuit element configurations, using both logical and physical layout data, as desired by the user.

### FIELD OF THE INVENTION

The present invention is directed to a programmable tool for performing electrical rule checking of an integrated circuit design using electronic design automation operations. Various implementations of the invention may be useful for employing both logical and physical design information check an integrated circuit design

### BACKGROUND OF THE INVENTION

Many microdevices, such as integrated circuits, have become so complex that these devices cannot be manually designed. For example, even a simple microprocessor may have millions and millions of transistors that cooperate to form the components of the microprocessor. As a result, electronic design automation tools have been created to assist circuit designers in analyzing a circuit design before it is manufactured. These electronic design automation tools typically will execute one or more electronic design automation (EDA) processes to verify that the circuit design complies with specified requirements, identify problems in the design, modify the circuit design to improve its manufacturability, or some combination thereof. For example, some electronic design automation tools may provide one or more processes for simulating the operation of a circuit manufactured from a circuit design to verify that the design will provides the desired functionality. Still other electronic design automation tools may alternately or additionally provide one or more processes for confirming that a circuit design matches the intended circuit schematic, for identifying portions of a circuit design that do not comply with preferred design conventions, for identifying flaws or other weaknesses the design, or for modifying the circuit design to address any of these issues. Examples of electronic design automation tools include the Calibre family of software tools available from Mentor Graphics Corporation of Wilsonville, Oreg.

As electronic devices continue to have smaller and smaller features and become more complex, greater sophistication is being demanded from electronic design automation tools. For example, in addition to detecting obvious design flaws, many electronic design automation tools are now expected to identify those design objects in a design that have a significant likelihood of being improperly formed during the manufacturing process, operating improperly after being manufactured, and/or identify design changes that will allow the design objects to be more reliably manufactured during the manufacturing process or operate more reliably after manufacturing. In order to meet these expectations, a process executed by an electronic design automation tool may need to perform more calculations on a wider variety of data than with previous generations of electronic design automation tools.

Electrical rule checking (ERC) is a methodology used to check the validity of a design against various “electronic design rules.” These design rules are often project-specific and developed based on knowledge from previous tape-outs or in anticipation of potential new failures. Not complying with these rules can result in reduced yield, defect escapes to customers, and delayed failures in the field. Traditional approaches to electrical rule checking may involve circuit simulation or fault analysis. Simulation or manual checking can start to break down with increasing design sizes and layout dependency-related issues. Simulators, for example, may have difficulty handling large designs, and the chances of missing errors during manual checking increases as the complexity of a design increases.

### BRIEF SUMMARY OF THE INVENTION

Aspects of the invention relate to electrical rule checking techniques for analyzing integrated circuit design data to identify specified circuit element configurations. As will be discussed in detail below, embodiments of both tools and methods implementing these techniques may be employed to identify circuit element configurations using both logical and physical layout information for the design data. According to various implementations of the invention, a set of commands are provided that will allow a user to program a programmable electrical rule check tool to identify a wide variety of circuit element configurations, using both logical and physical layout data, as desired by the user.

Some implementations of the invention may provide both low-level commands, which may be used to identify circuit elements with specific characteristics, and high level commands that use information obtained through the low-level commands to identify specified circuit element configurations. With some implementations of the invention, one or more of the low-level commands may generate state data describing a set of the identified circuit elements having the specified characteristics. This state data can then be used by one or more of the high-level commands to identify specified circuit element configurations. Various embodiments of the invention may provide a programmable electrical rule check tool that operates natively on hierarchical integrated circuit design data.

These and other features and aspects of the invention will be apparent upon consideration of the following detailed description.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 schematically illustrates an example of a family of software tools for automatic design automation that may employ associative properties according to various embodiments of the invention.

FIG. 4 illustrates geometric elements in a microcircuit layout design that may be associated with one or more properties according to various embodiments of the invention.

FIG. 5 illustrates one example of a type of array that may be employed by various embodiments of the invention.

### DETAILED DESCRIPTION OF THE INVENTION

### Exemplary Operating Environment

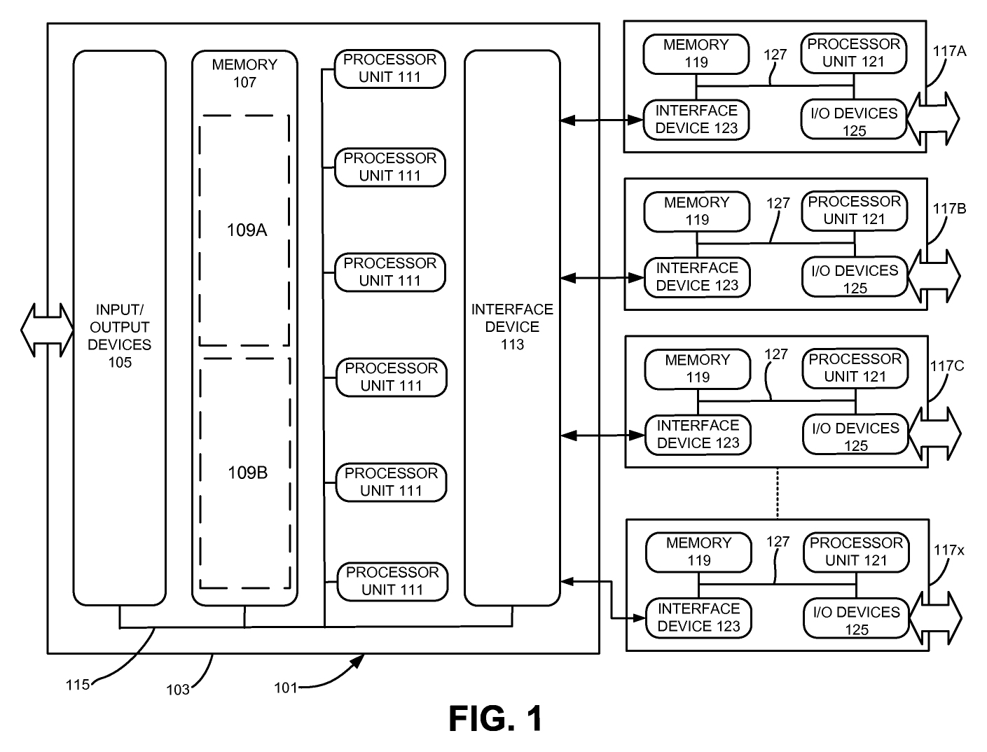

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

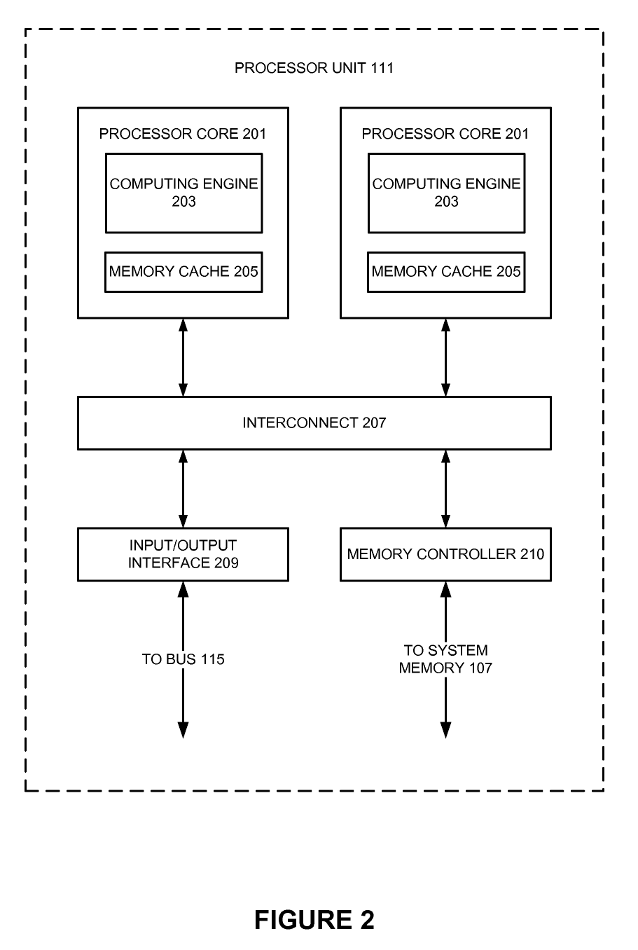

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Electronic Design Automation

As previously noted, various embodiments of the invention are related to electronic design automation. In particular, various implementations of the invention may be used to improve the operation of electronic design automation software tools that identify, verify and/or modify design data for manufacturing a microdevice, such as a microcircuit. As used herein, the terms “design” and “design data” are intended to encompass data describing an entire microdevice, such as an integrated circuit device or micro-electromechanical system (MEMS) device. This term also is intended to encompass a smaller set of data describing one or more components of an entire microdevice, however, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. It should be noted that, unless otherwise specified, the term “design” as used herein is intended to encompass any type of design, including both a physical layout design and a logical design.

Designing and fabricating microcircuit devices involve many steps during a ‘design flow’ process. These steps are highly dependent on the type of microcircuit, its complexity, the design team, and the fabricator or foundry that will manufacture the microcircuit from the design. Several steps are common to most design flows, however. First, a design specification is modeled logically, typically in a hardware design language (HDL). Once a logical design has been created, various logical analysis processes are performed on the design to verify its correctness. More particularly, software and hardware “tools” verify that the logical design will provide the desired functionality at various stages of the design flow by running software simulators and/or hardware emulators, and errors are corrected. For example, a designer may employ one or more functional logic verification processes to verify that, given a specified input, the devices in a logical design will perform in the desired manner and provide the appropriate output.

In addition to verifying that the devices in a logic design will provide the desired functionality, some designers may employ a design logic verification process to verify that the logical design meets specified design requirements. For example, a designer may create rules such as, e.g., every transistor gate in the design must have an electrical path to ground that passes through no more than three other devices, or every transistor that connects to a specified power supply also must be connected to a corresponding ground node, and not to any other ground node. A design logic verification process then will determine if a logical design complies with specified rules, and identify occurrences where it does not.

After the logical design is deemed satisfactory, it is converted into physical design data by synthesis software. This physical design data or “layout” design data may represent, for example, the geometric elements that will be written onto a mask used to fabricate the desired microcircuit device in a photolithographic process at a foundry. For conventional mask or reticle writing tools, the geometric elements typically will be polygons of various shapes. Thus, the layout design data usually includes polygon data describing the features of polygons in the design. It is very important that the physical design information accurately embody the design specification and logical design for proper operation of the device. Accordingly, after it has been created during a synthesis process, the physical design data is compared with the original logical design schematic in a process sometimes referred to as a “layout-versus-schematic” (LVS) process.

Once the correctness of the logical design has been verified, and geometric data corresponding to the logical design has been created in a layout design, the geometric data then may be analyzed. For example, because the physical design data is employed to create masks used at a foundry, the data must conform to the foundry's requirements. Each foundry specifies its own physical design parameters for compliance with their processes, equipment, and techniques. Accordingly, the design flow may include a process to confirm that the design data complies with the specified parameters. During this process, the physical layout of the circuit design is compared with design rules in a process commonly referred to as a “design rule check” (DRC) process. In addition to rules specified by the foundry, the design rule check process may also check the physical layout of the circuit design against other design rules, such as those obtained from test chips, general knowledge in the industry, previous manufacturing experience, etc.

With modern electronic design automation design flows, a designer may additionally employ one or more “design-for-manufacture” (DFM) software tools. As previously noted, design rule check processes attempt to identify, e.g., elements representing structures that will almost certainly be improperly formed during a manufacturing process. “Design-For-Manufacture” tools, however, provide processes that attempt to identify elements in a design representing structures with a significant likelihood of being improperly formed during the manufacturing process. A “design-for-manufacture” process may additionally determine what impact the improper formation of the identified elements will have on the yield of devices manufactured from the circuit design, and/or modifications that will reduce the likelihood that the identified elements will be improperly formed during the manufacturing process. For example, a “design-for-manufacture” (DFM) software tool may identify wires that are connected by only a single via, determine the yield impact for manufacturing a circuit from the design based upon the probability that each individual single via will be improperly formed during the manufacturing process, and then identify areas where redundant vias can be formed to supplement the single vias.

It should be noted that, in addition to “design-for-manufacture,” various alternate terms are used in the electronic design automation industry. Accordingly, as used herein, the term “design-for-manufacture” or “design-for-manufacturing” is intended to encompass any electronic design automation process that identifies elements in a design representing structures that may be improperly formed during the manufacturing process. Thus, “design-for-manufacture” (DFM) software tools will include, for example, “lithographic friendly design” (LFD) tools that assist designers to make trade-off decisions on how to create a circuit design that is more robust and less sensitive to lithographic process windows. They will also include “design-for-yield” (DFY) electronic design automation tools, “yield assistance” electronic design automation tools, and “chip cleaning” and “design cleaning” electronic design automation tools.

After a designer has used one or more geometry analysis processes to verify that the physical layout of the circuit design is satisfactory, the designer may then perform one or more simulation processes to simulate the operation of a manufacturing process, in order to determine how the design will actually be realized by that particular manufacturing process. A simulation analysis process may additionally modify the design to address any problems identified by the simulation. For example, some design flows may employ one or more processes to simulate the image formed by the physical layout of the circuit design during a photolithographic process, and then modify the layout design to improve the resolution of the image that it will produce during a photolithography process.

These resolution enhancement techniques (RET) may include, for example, modifying the physical layout using optical proximity correction (OPC) or by the addition of sub-resolution assist features (SRAF). Other simulation analysis processes may include, for example, phase shift mask (PSM) simulation analysis processes, etch simulation analysis processes and planarization simulation analysis processes. Etch simulation analysis processes simulate the removal of materials during a chemical etching process, while planarization simulation processes simulate the polishing of the circuit's surface during a chemical-mechanical etching process. These simulation analysis processes may identify, for example, regions where an etch or polishing process will not leave a sufficiently planar surface. These simulation analysis processes may then modify the physical layout design to, e.g., include more geometric elements in those regions to increase their density.

Once a physical layout design has been finalized, the geometric elements in the design are formatted for use by a mask or reticle writing tool. Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool. Accordingly, the larger geometric elements in a physical layout design data will typically be “fractured” into the smaller, more basic polygons that can be written by the mask or reticle writing tool.

It should be appreciated that various design flows may repeat one or more processes in any desired order. Thus, with some design flows, geometric analysis processes can be interleaved with simulation analysis processes and/or logical analysis processes. For example, once the physical layout of the circuit design has been modified using resolution enhancement techniques, then a design rule check process or design-for-manufacturing process may be performed on the modified layout, Further, these processes may be alternately repeated until a desired degree of resolution for the design is obtained. Similarly, a design rule check process and/or a design-for-manufacturing process may be employed after an optical proximity correction process, a phase shift mask simulation analysis process, an etch simulation analysis process or a planarization simulation analysis process. Examples of electronic design tools that employ one or more of the logical analysis processes, geometry analysis processes or simulation analysis processes discussed above are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

### Software Tools for Simulation, Verification or Modification of a Circuit Layout

To facilitate an understanding of various embodiments of the invention, one such software tool for automatic design automation, directed to the analysis and modification of a design for an integrated circuit, will now be generally described. As previously noted, the terms “design” and “design data” are used herein to encompass data describing an entire microdevice, such as an integrated circuit device or micro-electromechanical system (MEMS) device. These terms also are intended, however, to encompass a smaller set of data describing one or more components of an entire microdevice, such as a layer of an integrated circuit device, or even a portion of a layer of an integrated circuit device. Still further, the terms “design” and “design data” also are intended to encompass data describing more than one microdevice, such as data to be used to create a mask or reticle for simultaneously forming multiple microdevices on a single wafer. As also previously noted, unless otherwise specified, the term “design” as used herein is intended to encompass any type of design, including both physical layout designs and logical designs.

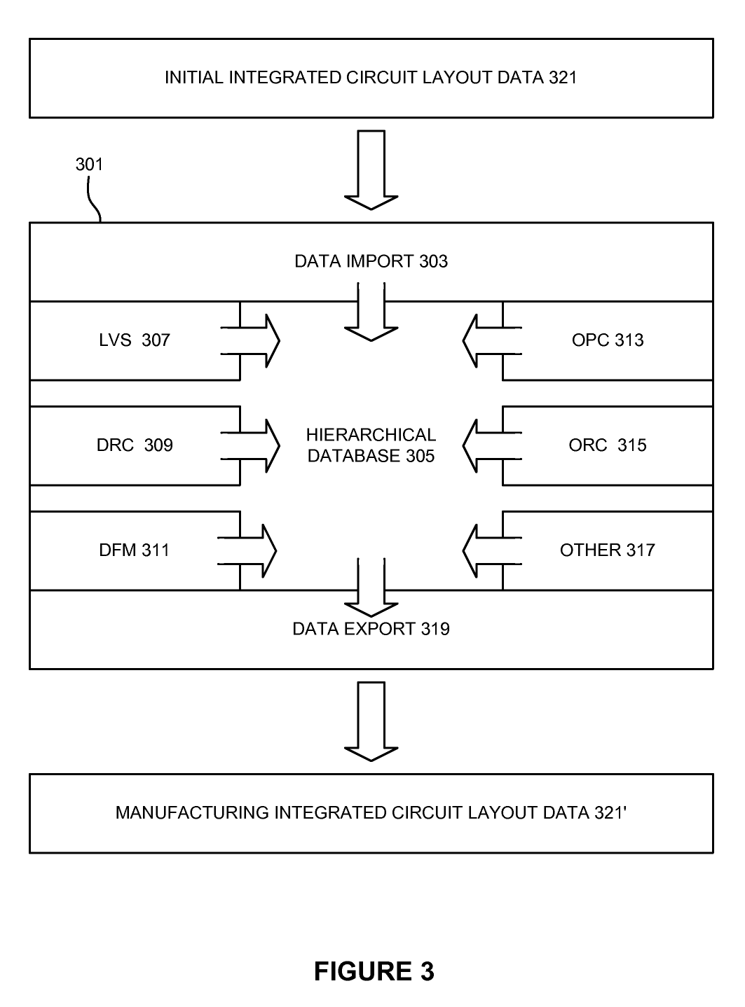

As seen in FIG. 3, an analysis tool 301, which may be implemented by a variety of different software applications, includes a data import module 303 and a hierarchical database 305. The analysis tool 301 also includes a layout-versus-schematic (LVS) verification module 307, a design rule check (DRC) module 309, a design-for-manufacturing (DFM) module 311, an optical proximity correction (OPC) module 313, and an optical proximity rule check (ORC) module 315. The analysis tool 301 may further include other modules 317 for performing additional functions as desired, such as a phase shift mask (PSM) module (not shown), an etch simulation analysis module (not shown) and/or a planarization simulation analysis module (not shown). The tool 301 also has a data export module 319. One example of such an analysis tool is the Calibre family of software applications available from Mentor Graphics Corporation of Wilsonville, Oreg.

Initially, the tool 301 receives data 321 describing a physical layout design for an integrated circuit. The layout design data 321 may be in any desired format, such as, for example, the Graphic Data System II (GDSII) data format or the Open Artwork System Interchange Standard (OASIS) data format proposed by Semiconductor Equipment and Materials International (SEMI). Other formats for the data 321 may include an open source format named Open Access, Milkyway by Synopsys, Inc., and EDDM by Mentor Graphics, Inc. The layout data 321 includes geometric elements for manufacturing one or more portions of an integrated circuit device. For example, the initial integrated circuit layout data 321 may include a first set of polygons for creating a photolithographic mask that in turn will be used to form an isolation region of a transistor, a second set of polygons for creating a photolithographic mask that in turn will be used to form a contact electrode for the transistor, and a third set of polygons for creating a photolithographic mask that in turn will be used to form an interconnection line to the contact electrode. The initial integrated circuit layout data 321 may be converted by the data import module 303 into a format that can be more efficiently processed by the remaining components of the tool 301.

Once the data import module 303 has converted the original integrated circuit layout data 321 to the appropriate format, the layout data 321 is stored in the hierarchical database 305 for use by the various operations executed by the modules 305-317. Next, the layout-versus-schematic module 307 checks the layout design data 321 in a layout-versus-schematic process, to verify that it matches the original design specifications for the desired integrated circuit. If discrepancies between the layout design data 321 and the logical design for the integrated circuit are identified, then the layout design data 321 may be revised to address one or more of these discrepancies. Thus, the layout-versus-schematic process performed by the layout-versus-schematic module 307 may lead to a new version of the layout design data with revisions. According to various implementations of the invention tool 301, the layout data 321 may be manually revised by a user, automatically revised by the layout-versus-schematic module 307, or some combination thereof.

Next, the design rule check module 309 confirms that the verified layout data 321 complies with defined geometric design rules. If portions of the layout data 321 do not adhere to or otherwise violate the design rules, then the layout data 321 may be modified to ensure that one or more of these portions complies with the design rules. The design rule check process performed by the design rule check module 309 thus also may lead to a new version of the layout design data with various revisions. Again, with various implementations of the invention tool 301, the layout data 321 may be manually modified by a user, automatically modified by the design rule check module 309, or some combination thereof.

The modified layout data 321 is then processed by the design for manufacturing module 311. As previously noted, a “design-for-manufacture” processes attempts to identify elements in a design representing structures with a significant likelihood of being improperly formed during the manufacturing process. A “design-for-manufacture” process may additionally determine what impact the improper formation of the identified structures will have on the yield of devices manufactured from the circuit design, and/or modifications that will reduce the likelihood that the identified structures may be improperly formed during the manufacturing process. For example, a “design-for-manufacture” (DFM) software tool may identify wires that are connected by single vias, determine the yield impact based upon the probability that each individual single via will be improperly formed during the manufacturing process, and then identify areas where redundant visa can be formed to supplement the single vias.

The processed layout data 321 is then passed to the optical proximity correction module 313, which corrects the layout data 321 for manufacturing distortions that would otherwise occur during the lithographic patterning. For example, the optical proximity correction module 313 may correct for image distortions, optical proximity effects, photoresist kinetic effects, and etch loading distortions. The layout data 321 modified by the optical proximity correction module 313 then is provided to the optical process rule check module 315

The optical process rule check module 315 (more commonly called the optical rules check module or ORC module) ensures that the changes made by the optical proximity correction module 313 are actually manufacturable, a “downstream-looking” step for layout verification. This compliments the “upstream-looking” step of the LVS performed by the LVS module 307 and the self-consistency check of the DRC process performed by the DRC module 309, adding symmetry to the verification step. Thus, each of the processes performed by the design for manufacturing process 311, the optical proximity correction module 313, and the optical process rule check module 315 may lead to a new version of the layout design data with various revisions.

As previously noted, other modules 317 may be employed to perform alternate or additional manipulations of the layout data 321, as desired. For example, some implementations of the tool 301 may employ, for example, a phase shift mask module. As previously discussed, with a phase-shift mask (PSM) analysis (another approach to resolution enhancement technology (RET)), the geometric elements in a layout design are modified so that the pattern they create on the reticle will introduce contrast-enhancing interference fringes in the image. The tool 301 also may alternately or additionally employ, for example, an etch simulation analysis processes or a planarization simulation analysis processes. The process or processes performed by each of these additional modules 317 may also lead to the creation of a new version of the layout data 321 that includes revisions.

After all of the desired operations have been performed on the initial layout data 321, the data export module 319 converts the processed layout data 321 into manufacturing integrated circuit layout data 323 that can be used to form one or more masks or reticules to manufacture the integrated circuit (that is, the data export module 319 converts the processed layout data 321 into a format that can be used in a photolithographic manufacturing process). Masks and reticles typically are made using tools that expose a blank reticle or mask substrate to an electron or laser beam (or to an array of electron beams or laser beams), but most mask writing tools are able to only “write” certain kinds of polygons, however, such as right triangles, rectangles or other trapezoids. Moreover, the sizes of the polygons are limited physically by the maximum beam (or beam array) size available to the tool.

Accordingly, the data export module 319 may “fracture” larger geometric elements in the layout design, or geometric elements that are not right triangles, rectangles or trapezoids (which typically are a majority of the geometric elements in a layout design) into the smaller, more basic polygons that can be written by the mask or reticle writing tool. Of course, the data export module 319 may alternately or additionally convert the processed layout data 321 into any desired type of data, such as data for use in a synthesis process (e.g., for creating an entry for a circuit library), data for use in a place-and-route process, data for use in calculating parasitic effects, etc. Further, the tool 301 may store one or more versions of the layout 321 containing different modifications, so that a designer can undo undesirable modifications. For example, the hierarchical database 305 may store alternate versions of the layout data 321 created during any step of the process flow between the modules 307-317.

### Data Organization

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with specified design rules. With the above example, instead of having to analyze each feature in the entire 128 kB memory array, a design rule check process can analyze the features in a single bit cell. If the cells are identical, then the results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

With various examples of the invention, layout design data may include two different types of data: “drawn layer” design data and “derived layer” design data. The drawn layer data describes geometric elements that will be used to form structures in layers of material to produce the integrated circuit. The drawn layer data will usually include polygons that will be used to form structures in metal layers, diffusion layers, and polysilicon layers. The derived layers will then include features made up of combinations of drawn layer data and other derived layer data. Thus, with a transistor gate, derived layer design data describing the gate may be derived from the intersection of a polygon in the polysilicon material layer and a polygon in the diffusion material layer.

For example, a design rule check process performed by the design rule check module 309 typically will perform two types of operations: “check” operations that confirm whether design data values comply with specified parameters, and “derivation” operations that create derived layer data. A transistor gate design data thus may be created by the following derivation operation:

gate=diff AND poly

The results of this operation will be a “layer” of data identifying all intersections of diffusion layer polygons with polysilicon layer polygons. Likewise, a p-type transistor gate, formed by doping the diffusion layer with n-type material, is identified by the following derivation operation:

pgate=nwell AND gate

The results of this operation then will be another “layer” of data identifying all transistor gates (i.e., intersections of diffusion layer polygons with polysilicon layer polygons) where the polygons in the diffusion layer have been doped with n-type material.

A check operation performed by the design rule check module 309 will then define a parameter or a parameter range for a data design value. For example, a user may want to ensure that no metal wiring line is within a micron of another wiring line. This type of analysis may be performed by the following check operation:

external metal<1

The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

### Properties

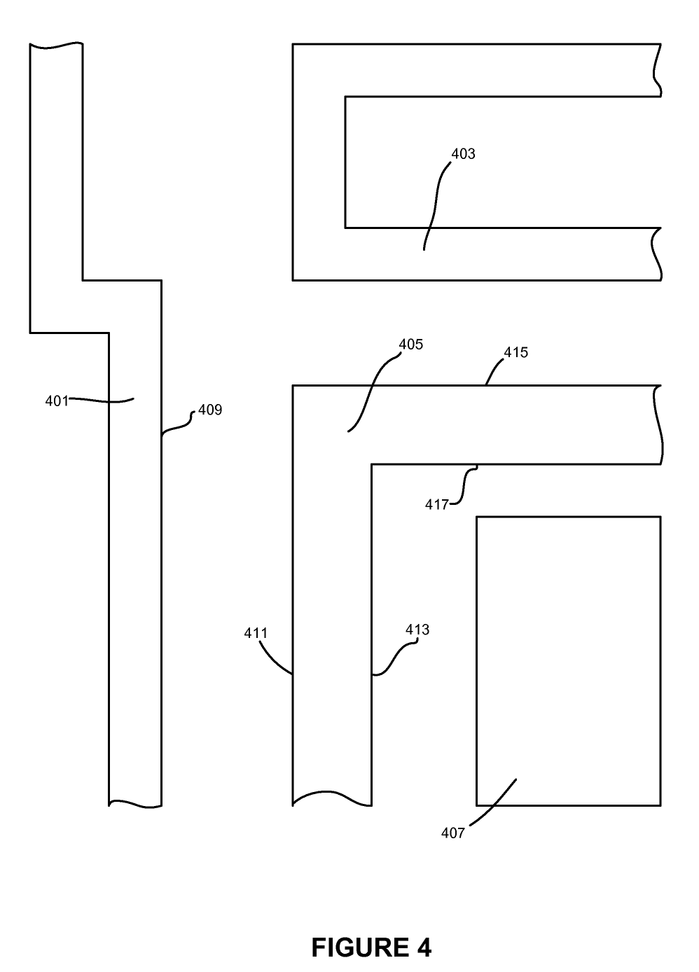

Various implementations of the invention relate to software tools for electronic design automation that create and/or employ associative properties. As will be discussed in more detail below, with some implementations of the invention, one or more properties can be generated and associated with any type of design object in a microdevice design. If the design is a physical layout for lithographically manufacturing an integrated circuit or other microdevice, for example, then one or more properties can be associated with any desired geometric element described in the design. Referring now to FIG. 4, this figure illustrates a portion of a layout design. The design includes a plurality of polygons 401-407 that will be used to form circuit structures in a layer of material, such as a layer of metal. Polygons 401-405, for example, may be used to form wiring lines for an integrated circuit. With various examples of the invention, one or more properties can be associated with a polygon, such as each of the polygons 401-407, or with a component of a polygon, such as the vertices of a polygon. Further, one or more properties can be associated with a polygon's edge, such as the edge 409 of the polygon 401. Still further, one or more properties can be associated with a pair of polygon edges, such as the edges 411 and 413 of the polygon 405. With various examples of the invention, each property may be represented as a new “layer” of data in the design.

When a property is associated with a design object in a layout design, its value may be derived from geometric data related to that design object. For example, if a property is associated with geometric element, such as a polygon, then it may have a value derived from the area of the polygon, the perimeter of the polygon, the number of vertices of the polygon, or the like. Similarly, if a property is associated with an edge, then the value of the property may be derived from the length or angle of the edge. Still further, if a property is associated with a pair of edges, then the value of the property may be derived from a separation distance between the edges, a total length of the edges, a difference in length between the edges, an area bounded by the edges, etc.

As will be apparent from the discussion below, however, it should be appreciated that a property value can be defined by any desired function. For example, a property may be defined as a constant value. The value of a property x thus may be defined by the function:

x=0.5

With this definition, the value of the property will always be 0.5.

A property's value also may be defined by a variable function. With a variable function, the value of a property may vary based upon, e.g., the specific data in the design. For example, a property x may be defined by the simple function:

X=AREA(METAL1)*0.5+(PERIMETER(METAL1)²

With this function, a property value is generated for every polygon in the design layer named “metal1.” (That is, the input used to generate the property x is the data layer in the design name “metal1.”) For each polygon in the design layer, the area of the polygon is calculated and multiplied by 0.5. In addition, the perimeter of the polygon is determined, and then squared. The multiplicand of the polygon's area with 0.5 is then added to the square of the polygon's perimeter to generate the value of the property x for associated with that polygon.

Thus, in FIG. 4, if the perimeter of the first polygon 401 is 68, and the area of the first polygon is 64, then the value of the property x₁ for the first polygon is

x₁=(64*0.5)+(68)²=4656

Similarly, if the perimeter of the second polygon 403 is 60 and the area of the second polygon is 66, then the value of the property x₂ of the second polygon is

x₂=(60*0.5)+(66)²=4386.

Still further, if the perimeter of the third polygon 405 is 60 and the area of the second polygon is 84, then the value of the property x₃ of the third polygon is

x₁=(60*0.5)+(84)²=7086,

and if the perimeter of the fourth polygon 407 is 34 and the area of the second polygon is 70, then the value of the property x₄ of the fourth polygon is

x₄=(34*0.5)+(70)²=4917

In addition to a “simple” function like that described above, a property also may be defined by a compound function that incorporates a previously-generated property value. For example, a first property x may be defined by the simple function described above:

X=AREA(METAL1)*5+(PERIMETER(METAL1))²

A second property, Y, can then be defined by a function that incorporates the value of the first property x, as follows:

Y=PROP(METAL1,X)+1

Thus, the value of the property Y for a polygon is the value of the property x calculated for that polygon, plus one.

In addition to being defined by simple and compound functions, a property may be defined so that no property value is generated under some conditions. For example, a property associated with a polygon may be defined so that, if the area of the polygon is smaller than a threshold value, then no value is generated for the property. This feature may be useful where, for example, property values need only be generated for design objects having desired characteristics. If a design object does not have the required characteristics, then no property will be generated for the design object and it can be ignored in subsequent calculations using the generated property values.

More generally, a property's value may be defined by alternative functions, such as the functions below:

IF AREA(METAL1)<0.5, THEN X=1

IF AREA(METAL1)≧1, THEN X=AREA(METAL1)*0.5+(PERIMETER(METAL1))²

With these alternative functions, each polygon in the data layer “metal1” is analyzed. If the area of the polygon is below 0.5, then the value of the property x for the polygon is 1. Otherwise, the value of the property x for the polygon is the area of the polygon multiplied by 0.5, added to the square of the perimeter of the polygon.

A property may have multiple values. For example, a property may have an x-coordinate value, a y-coordinate value, and a z-coordinate value. Moreover, a property may have multiple, heterogeneous values. For example, a property may have a numerical value and a string value. Thus, a property associated with a cell can have a numerical value that may be, e.g., a device count of devices in the cell, while the string value may be, e.g., a model name identifying the library source for the cell. Of course, a property with multiple heterogeneous values can include any combination of value types, including any combination of the value types described above (e.g., one or more constant values, one or more vector values, one or more dynamic values, one or more alternate values, one or more simple values, one or more compound values, one or more alternate values, one or more string values, etc.).

Still further, the number of values of a property may change dynamically change. For example, a property K may have the values “a” and “b” (i.e., value of property K=a, b) before an electronic design automation process is executed. The electronic design automation process may then change the property to include a third value “c” (i.e., value of property K=a, b, c). Of course, the electronic design automation process also may alternately or additionally change the values of property K to one or more completely different values (e.g., value of property K=d, e, f). Moreover, with some implementations of the invention, the value of a property at one time may depend upon the value of the property at a previous time. For example, the value of a property Q at time t₂ may be derived from the value of the property Q at time t₁. Of course, in addition to constant values, and values generated based upon simple, compound, or alternative variable functions, a property's value can be specified according to any desired definition. For example, in addition to single or alternate mathematical functions, the value of a property may even be an array of constant values, variable functions, or some combination thereof. It should be appreciated, however, that, by using a scripting language as described above, property values can be dynamically generated during an electronic design automation process.

That is, by specifying property value definitions using a scripting language, the actual property values can be generated based upon the definitions when the design is analyzed during an electronic design automation process. If the data in the design is changed, then the property values will automatically be recalculated without requiring further input from the designer. Thus, employing a scripting language allows a designer or other user to develop properties and determine their values as needed. It also may provide the flexibility to allow third parties to develop new analysis techniques and methods, and then specify scripts that allow the user of an electronic design automation tool to use the scripts developed by a third party to generate property values for use with those new techniques and methods.

As previously noted, a property may be associated with any desired type of design object in a design. Thus, in addition to a single geometric element in a layout design, such as a polygon, edge, or edge pair, a property also can be associated with a group of one or more design objects in a layout design. For example, a property may be associated with a group of polygons or a hierarchical cell in a layout design (which themselves may be considered together as a single design object). A property also may be associated with an entire category of one or more design objects. For example, a property may be associated with every occurrence of a type of design object in a design layer, such as with every cell in a design, or every instance of a type of geometric element occurring in a design. A property also may be specifically associated with a particular placement of a cell in a design. In addition to design objects in a layout design, properties also may be associated with design objects in other types of designs, such as logical designs. A property thus may be associated with any desired object in a logical design, such as a net, a device, an instance of a connection pin, or even a placement of a cell in the design.

It also should be appreciated that, with various embodiments of the invention, a property associated with one design object also can be associated with another design object. Further, a property's value may be calculated using geometric or logical data for any desired design object, including design objects different from the design object with which the property is associated. With some implementations of the invention, a property's value may even be calculated using geometric or logical data for one or more design objects from multiple design data layers. For example, a designer may specify a design layer entitled “pair” that includes any specified edge pairs in a layout design, and another design layer entitled “edge” that includes specified edges in a layout design. A designer can then define a property z for each edge in the edge layer as:

Z=AREA(METAL1)/LENGTH(EDGE)+EW(PAIR)

where AREA is the area of one or more polygons related to the edge, LENGTH is the length of the edge, and EW is the width between the edges of an edge pair related to the edge. Thus, the value of the property Z for an edge is dependent upon the area of some other polygon related to the edge.

With some implementations of the invention, various algorithms can be used to define which design objects, such as geometric elements, will be related to each other for use in a property definition. For example, the definition for property z above may employ a relationship algorithm that includes a polygon in the property value determination if the polygon touches the edge associated with the property, and includes an edge pair in the property value determination if one edge is the edge associated with the property and the second edge is connected to the first edge through a polygon (i.e., both edges are part of the same polygon, as opposed to being separated by an empty space).

Of course, any desired algorithms can be used to determine which design objects will be related to each other for determining the value of a property. Other possible relationship algorithms for physical layout designs, for example, may relate all geometric elements that overlap, all geometric elements that intersect, all geometric elements that touch or otherwise contact each other, or all geometric elements that are within a defined proximity of another geometric element. With still other relationship algorithms, if one geometric element touches multiple geometric elements, the algorithms can decide to treat the touching geometric elements as errors, or to relate all touched shapes. Still other relationship algorithms can employ clipping, where, e.g., if a first geometric element intersects a second geometric element, only the part of the second geometric element inside the first geometric element is employed when determining a property value, etc.

Similarly, a variety of relationship algorithms can be used to relate design objects in a logical design to each other for use in a property definition. For example, a property definition may relate all design objects that belong to the same logical device, all design objects that share a common net, or all design objects that share a reference identifier with, e.g., the design object with which the property is associated. Of course, still other relationship criteria can be employed to relate design objects in designs to each other for use in a property definition.

Further, by defining a second property value so that it incorporates a first property value, a property value associated with any design object or group of design objects can be associated with any other design object or group of design objects. For example, a property for a first polygon may be the area of that polygon. A property for a second polygon touching or contacting that first polygon can then be defined as the area of the first polygon. In this manner, a property value associated with the first polygon can be associated with the second polygon. Thus, a property associated with a geometric element also can be associated with a cell incorporating that geometric element. Similarly, a property associated with a geometric element can be associated with an adjacent geometric element. Still further, a property of a geometric element can be associated with the entire data layer in a design.

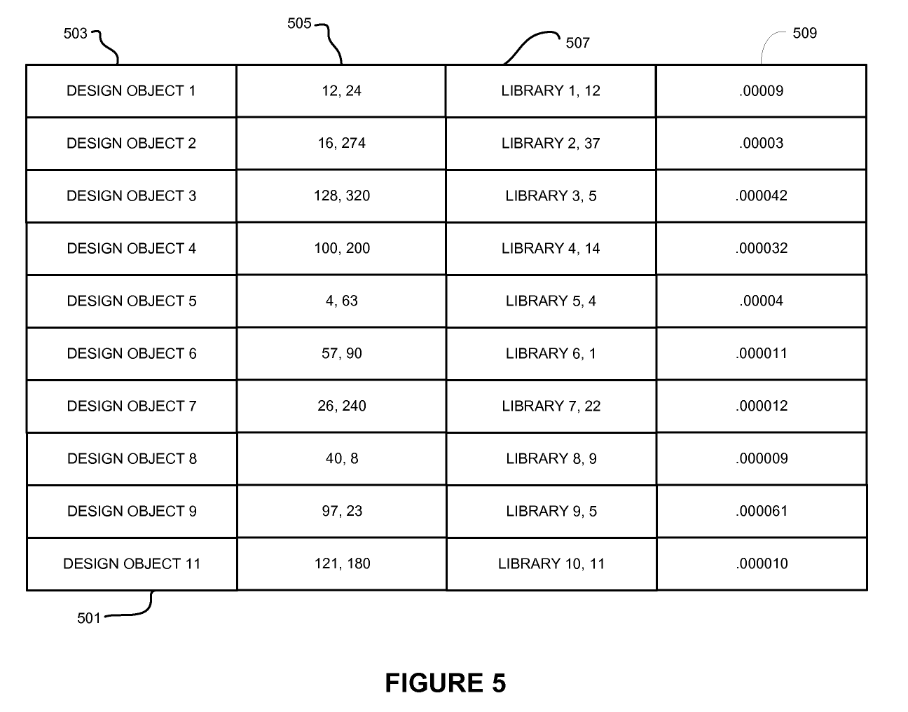

With various implementations of the invention, the value of a property associated with a design object property value is separate from a description of the design object with which the property is associated. That is, with various implementations of the invention the value of a property is not simply a characteristic of the design object with which the property is associated, but instead may be considered a distinct design object itself. According to some implementations of the invention, for example, the property values for various design objects may be stored in an array. FIG. 5 illustrates one example of a type of array that may be employed by various implementations of the invention. As seen in this figure, the array 501 includes a column listing identifiers 503. It also includes a column with property values 505 for a property G, a column with property values 505 for a property H, and a column with property values 505 for a property I.

Each identifier 503 identifies an occurrence of a design object associated with each of the properties G, H, and I. With the illustrated example, the design object may be, e.g., a type of cell in a hierarchical physical layout design. The definition for the property G then may be the coordinate value for the placement of the cell, while the definition of the property H may be both the library from which the cell was obtained and the count of the cell in the design. The definition of the property I then may be the percentage at which the structure described in the cell will be improperly formed during a manufacturing process. From the array 501, it can thus be determined that, e.g., the cell “design object 8” is located at the x, y coordinate values 40, 8 in the design, was originally obtained from library 8, and is the ninth occurrence of that cell in the design. Also, the value of property I for this cell indicates that it has a 0.000009% failure rate when manufactured.

While a table-type array is illustrated in FIG. 5 for each of understanding, it should be appreciated that, as used herein, the term “array” is intended to encompass any type of data structure that behaves like a logical array. Thus, various implementations of the invention may alternately or additionally employ, for example, such structures as a Calibre number table (used with the Calibre family of software tools available from Mentor Graphics Corporation of Wilsonville, Oreg.) or a Standard Template Library (STL) deque. It also should be appreciated that, while FIG. 5 illustrates a single set of property values for each design object, various implementations of the invention may allow multiple identifies to be associated with a single set of property values. This arrangement may be beneficial, e.g., for reducing memory usage where one or more design objects will have the same value for an associated property. Also, it should be noted that various implementations of the invention may update a property value by overwriting or otherwise replacing the previous property value in memory with the updated property value, to conserve memory usage.

### Programmable Electrical Rule Checking

As noted above, various implementations of the invention provide a programmable electrical rule check (PERC) tool. According to various examples of the invention, the programmable electrical rule check tool may be a general purpose netlist-based tool. For example, a user may employ the commands provide by implementations of a programmable electrical rule check tool according to various embodiments of the invention electrical rule check tool to perform path checks, or electrostatic discharge (ESD) protection circuits rule checks. Still further, implementations of a programmable electrical rule check tool according to various embodiments of the invention can operate on a layout geometry database, or on a corresponding source netlist. If the input data is a layout geometry database, some implementations of a programmable electrical rule check tool according to various embodiments of the invention will automatically perform a netlist extraction to extract a netlist from the layout geometry database.

A programmable electrical rule check tool according to various embodiments of the invention may be implemented as a standalone application, or it may be implemented as a tool that is partially or fully integrated with an electronic design automation layout-versus-schematic (LVS) verification tool, such as the LVS verification tool in the Calibre family of electronic design automation tools available from Mentor Graphics Corporation in Wilsonville, Oreg. With some implementations of a programmable electrical rule check tool according to various embodiments of the invention, the programmable electrical rule check tool will employ the same techniques as a layout-versus-schematic (LVS) verification tool for data preparation, such as, for example: reading an input netlist, creating graph data structures, resolving deep shorts, resolving high shorts, and flattening non-hcells, etc.

If requested, implementations of a programmable electrical rule check tool according to various embodiments of the invention may also perform netlist transformations, such as, for example, device reduction, logic injection, and gate recognition, each of which will be explained in more detail below. As a result, implementations of a programmable electrical rule check tool according to various embodiments of the invention may have the following features. First, they may provide a hierarchical mode of operation, which natively analyzes integrated circuit design data in a hierarchical format as described in detail above. Alternately or additionally, implementations of a programmable electrical rule check tool according to various embodiments of the invention may include logic identification functionality, which provides device reduction, gate recognition, and/or logic injection.

Some implementations of a programmable electrical rule check tool according to various embodiments of the invention may use the same rule file as a conventional layout-versus-schematic (LVS) verification tool. Still further, some implementations of a programmable electrical rule check tool according to various embodiments of the invention also may provide a Tool Command Language (Tcl) application programming interface (API). With a Tcl API, rule checks may be written as Tcl procedures. These implementations of the programmable electrical rule check tool will then execute the rule checks and write the results to a report file.

### Control Specification Statements

The following paragraphs list examples of generic command statements that may be used to control the operation of implementations of a programmable electrical rule check tool according to various embodiments of the invention.

The Report File command:

COMMAND1 <filename>

This statement specifies the report file name. It will be specified once in the rule file. Also, the <filename> parameter can contain environment variables.

The Netlist Selection command:

COMMAND2 {LAYOUT|SOURCE}

There can be two design databases listed in the rule file: the layout system and the source system. This statement specifies the system upon which the programmable electrical rule check tool operates. If not specified, the default is LAYOUT. This statement may appear at most once.

The Property Specification Command:
COMMAND3 [STRING] <component_type> [‘(’ <component_subtype> ‘)’ ] <property> [<property> . . . ]

The required <component_type> parameter specifies the device component type to which the statement applies. The optional <component_subtype> is a name that specifies the device component subtype to which this statement applies. This parameter, if present, must be enclosed in parentheses. If it is not present, then the statement applies to all instances of the specified component type, regardless of their subtype, except for subtypes that have their own COMMAND3 statements (that is, a statement with the same component type and with the component subtype of the instance).

The required <property> parameter specifies a valid device property. You can specify <property> any number of times in this statement, but each property must have a unique name.

The optional keyword STRING, if present, specifies that the <property>s listed in this statement are string properties. If STRING is not present, then the <property>s are numeric properties.

By default, implementations of a programmable electrical rule check tool according to various embodiments of the invention will only read device properties that are needed by an layout-versus-schematic (LVS) operation, such as the ones mentioned in the TRACE PROPERTY statements or COMMAND6 statements (discussed in more detail below). Those properties are automatically available for use during electrical rule checking.

The COMMAND3 statement instructs implementations of a programmable electrical rule check tool according to various embodiments of the invention to read the given list of properties (such as the properties described in detail above) from the input, regardless whether they are needed by a corresponding layout-versus-schematic (LVS) verification tool. These properties are then available for use during subsequent rule checking.

For each combination of <component_type>, <component_subtype>, and the keyword STRING, there can be at most one COMMAND3 statement. <component_type> is case sensitive if the COMMAND10 specification statement (discussed in more detail below) has been specified with the YES or TYPES parameter. <component_subtype> is case sensitive if the COMMAND10 specification statement has been specified with the YES or SUBTYPES parameter. Property names may always be case insensitive.

Examples of the use of this command are listed below:

| // Read width and length properties for all MP devices | | |
|---|---|---|
| COMMAND3 mp w l | | |
| // Read width and length properties for all MN devices, | | |
| // except for MN(na) devices, which need the area properties | | |
| COMMAND3 mn | w | l |
| COMMAND3 mn(na) | as | ad |

// Read two string properties for all resistors
COMMAND3 STRING r foo bar

The Rule Check Specification command:

COMMAND4 <name> [/*

<tcl_proc> [<tcl_proc> ...]

*/]

This statement specifies a Table-Value Function (TVF) that defines rule checks. It may appear any number of times, but each COMMAND4 must have a unique name. The required <name> parameter provides a name space for the contained rule checks. Each TVF is independent of any other TVF in the same rule file, and rule checks defined in different TVFs may share a name.

The required <tcl_proc> parameter has to be a valid Tcl proc. A user can specify any number of Tcl procs in a TVF, but each Tcl proc must have a unique name. While the TVF function names are case insensitive, the Tcl proc names typically will be case sensitive. All Tcl procs must appear between the literal square brackets “[/*” and “*/]”. The brackets must appear on separate lines from the Tcl code.

Each rule check is defined as a Tcl proc that takes no parameters. The commands that can be used in a rule check are described in the Tcl API sections below. Any auxiliary Tcl procs used by the rule checks also have to be contained in the same TVF. The order in which the Tcl procs are listed in a TVF is not significant.

Examples of the use of this command are listed below:

```
COMMAND4 test [/*
  proc setup { } {
    # PERC commands
  }
proc check_1 { } {
  # PERC commands
    }
  proc check_2 { } {
    # PERC commands
  }
  */]
```

The Rule Check Selection command:

```
COMMAND5 <tvf_function>
    [XFORM {REDUCTION | INJECTION | ALL}]
    [INIT <init_proc>]
    SELECT <check_proc> [<check_proc> ...]
```

This statement selects the rule checks to execute. By default, no rule checks are selected. Therefore, this statement must be present in the rule file for any results to be generated.

The required <tvf_function> parameter specifies the TVF to be loaded into the programmable electrical rule check tool's embedded Tcl interpreter. All Tcl procs mentioned in this statement must be defined in this TVF.

The optional keyword XFORM, if present, instructs the programmable electrical rule check tool to transform the netlist into the desired format before executing any Tcl procs. The allowed transformations may be those supported by a conventional layout-versus-schematic (LVS) verification tool, such as the layout-versus-schematic (LVS) verification tool available from Mentor Graphics Corporation of Wilsonville, Oreg., and enabled in the rule file. For example, these transformation may include:
DEVICE REDUCTION—controlled by COMMAND6 and COMMAND7.
LOGIC INJECTION—controlled by COMMAND8.
GATE RECOGNITION—controlled by COMMAND9.

These three choices may not independent, however. For example, with some implementations, if the choice is DEVICE REDUCTION, the programmable electrical rule check tool performs device reduction and unused device filtering. If the choice is LOGIC INJECTION, then the programmable electrical rule check tool performs device reduction, unused device filtering, and logic injection. Finally, if the choice is ALL, then the programmable electrical rule check tool does it all: device reduction, unused device filtering, logic injection, and gate recognition.

The optional keyword INIT specifies an initialization procedure. The parameter <init_proc> must be a Tcl proc defined in the TVF. <init_proc> follows the same convention as a rule check, and must not take any arguments. If present, the programmable electrical rule check tool executes <init_proc> first before running any rule checks.

The required parameter <check_proc> specifies a Tcl proc defined in the TVF. It is intended as a rule check so it must not take any arguments. A user can specify <check_proc> any number of times in this statement, but each <check_proc> must have a unique name. Also, the keyword SELECT and its list of <check_proc>s must be the last part of the COMMAND5 statement. Implementations of a programmable electrical rule check tool according to various embodiments of the invention will execute the rule checks one by one in the order listed. The results are sorted and written to the report file.

This statement may appear any number of times, and each COMMAND5 statement may be independent of any other in the same rule file. More precisely, a programmable electrical rule check tool according to various embodiments of the invention may process each COMMAND5 statement from the scratch. A new embedded Tcl interpretor is created. The netlist is reversed to its original state. The programmable electrical rule check tool then does the netlist transformation if specified. The initialization procedure, if provided, is run first before the programmable electrical rule check tool executes the rules checks listed in the statement.

For each combination of <tvf_function>, <init_proc> and the transformation choice, there can be at most one COMMAND5 statement. <tvf_function> is case insensitive, but <init_proc> is case sensitive. The transformation choice (REDUCTION, INJECTION, and ALL) is case insensitive.

The COMMAND5 statements are not necessarily processed in the order as they appear in the rule file. Instead, the programmable electrical rule check tool according to various embodiments of the invention arranges them into four groups and processes them in this order:
Group 1—all of the statements without netlist transformation
Group 2—all of the statements specifying REDUCTION
Group 3—all of the statements specifying INJECTION
Group 4—all of the statements specifying ALL

Within each group, the statements are processed in the order as they appear in the rule file. For example, assuming that the rule file has two TVFs and seven COMMAND5 statements:

```
COMMAND4 group_1 [/*
  proc setup_1 { } {
    # PERC commands
  }
  proc setup_2 { } {
    # PERC commands
  }
  proc check_1 { } {
    # PERC commands
  }
  proc check_2 { } {
    # PERC commands
  }
  proc check_3 { } {
    # PERC commands
  }
  proc check_4 { } {
    # PERC commands
  }
*/]
```

```
COMMAND4 group_2 [/*
  proc setup_a { } {
    # PERC commands
  }
  proc setup_b { } {
    # PERC commands
  }
  proc check_a { } {
    # PERC commands
  }
  proc check_b { } {
    # PERC commands
  }
  proc check_c { } {
    # PERC commands
  }
  proc check_d { } {
    # PERC commands
  }
  proc check_e { } {
    # PERC commands
  }
*/]
```

COMMAND5 group_1 INIT setup_1 SELECT check_1 check_2
COMMAND5 group_1 XFORM all INIT setup_2 SELECT check_3
COMMAND5 group_1 XFORM reduction INIT setup_1 SELECT check_4
COMMAND5 group_2 INIT setup_a SELECT check_a check_b
COMMAND5 group_2 XFORM injection INIT setup_b SELECT check_c
COMMAND5 group_2 XFORM reduction INIT setup_b SELECT check_d
COMMAND5 group_2 XFORM all INIT setup_a SELECT check_e

Implementations of a programmable electrical rule check tool according to various embodiments of the invention may execute the rule checks in this order: check_1, check_2, check_a, check_b, check_4, check_d, check_c, check_3, and check_e.

Alternately, assuming that the rule file has the following statements:
COMMAND7 MOS yes
COMMAND6 SPLIT GATES no
COMMAND8 no
COMMAND9 simple
COMMAND5 foo XFORM all SELECT bar

The choice of ALL in the COMMAND5 statement triggers the following netlist transformations: device reduction, unused device filtering, logic injection, and gate recognition. The transformations are done according to the control statements, such as the control statements that may be employed by a conventional layout-versus-schematic tool, such as a CALIBRE LVS tool available from Mentor Graphics Corporation of Wilsonville, Oreg. In the example above, unused MOS devices are filtered out. The structures enabled by the default reduction rules, such as parallel MOS devices, are reduced, but split gates are not reduced. Logic injection is not performed because it is disabled. Finally, simple gates are formed while complex gates are not.

The Device Reduction Command:

COMMAND6

This command provides generic device reduction instructions for reducing a plurality of devices into a single, corresponding device. For example, this command may be used to reduce a plurality of parallel resistor representations in a circuit design into a single, equivalent resistor representation. A component_type parameter specifies the component type to which this statement applies. It can be any component type.

The Filter Unused Command:

COMMAND7

This command controls the process of filtering out unused devices during a layout-versus-schematic operation.

The Inject Logic Command:

COMMAND8

This command specifies whether a layout-versus-schematic operation should internally substitute logic in the design. Logic injection may be used in hierarchical circuit comparison to reduce memory consumption by replacing common logic circuits with new, primitive elements.

The Gate Recognition Command:

COMMAND9

This command instructs a layout-versus-schematic operation to recognize the representation of logic gates from transistor-level data in a circuit design. For example, command may be used to have a layout-versus-schematic operation recognize an inverter from a particular arrangement of transistors.

The Case Comparison Command:

COMMAND10

This command controls the case sensitivity employed during a layout-versus-schematic operation.

The Power Name Command:

COMMAND11

This command can be used to specify a list of one or more independent power net names for use with a layout-versus-schematic operation. Power net names can be used by a layout-versus-schematic operation in, for example, logic gate recognition, filtering of unused MOS transistors, and in power supply verification. This statement can appear multiple times in a rule file.

The Filter Command:

COMMAND12

Filters out devices during the comparison phase based upon component type in both source and layout, and leaves the circuit shorted or open, depending on what is specified by user. This is the most general behavior. Further specified parameters, however, can be employed make the filter more restrictive.

### Tcl Application Programming Interface Overview

With some implementations of a programmable electrical rule check tool according to various embodiments of the invention, the Tcl API will provide all of the necessary commands for writing rule checks. Each command is a Tcl proc. The Tcl API can be divided into two categories: initialization commands and rule checking commands.

The initialization commands allow the user to initialize the netlist before executing any rule checks. Some implementations of a programmable electrical rule check tool according to various embodiments of the invention may support four initialization commands. These commands can only be used in COMMAND5 statements' initialization procedure.

The rule checking commands are further divided into two groups: low-level commands for accessing design elements (nets, devices, pins, etc), and high-level commands for performing complex tasks, such as defining rule checks.

Central to the low-level rule checking commands is the concept of iterators. An iterator is a Tcl construct that provides access to data in the input netlist. There are low-level commands to generate iterators, as well as various data access commands that return information about the object to which an iterator is pointing to, such as name and type. Iterators can also be stepped forward, thus the user can traverse all of the elements in the design hierarchy using iterators.

While flexible, the low-level commands can be tedious to use to write complex rule checks. For common tasks, implementations of a programmable electrical rule check tool according to various embodiments of the invention may provide a set of high-level rule checking commands that hide much of the procedural details from a user. For example, some implementations of a programmable electrical rule check tool according to various embodiments of the invention may provide a command (perc::commandβ discussed in detail below) that is a high-level command used to define rules for checking devices. At runtime, this command searches the entire input netlist, applies the user-provided condition to each device, and outputs all of the devices that meet the condition to the report file. Likewise, perc::commandα is a command for writing net-oriented rule checks. At runtime, perc::commandα searches the entire input netlist, applies the user-provided condition to each net, and outputs all of the nets that meet the condition to the report file. The low-level commands are often used to specify conditions used by the high-level commands.

The commands for various implementations of a programmable electrical rule check tool according to various embodiments of the invention may follow the naming conventions established in a conventional layout-versus-schematic (LVS) verification tool, such as a Calibre Layout-Versus-Schematic (LVS) verification tool available from Mentor Graphics Corporation of Wilsonville, Oreg. With these implementations, all of the built-in devices and their built-in pins provided by the conventional layout-versus-schematic (LVS) verification tool may be supported. For example, the following is the list of built-in device types and their corresponding built-in pins that may be supported by various implementations of a programmable electrical rule check tool according to various embodiments of the invention:
MOS types—g (or gate), s (or source), d (or drain), b (or bulk)
R—p (or pos), n (or neg)
C—p (or pos), n (or neg)
D—p (or pos), n (or neg)
Q—b (or base), c (or collector), e (or emitter)
J—g (or gate), s (or source), d (or drain), b (or bulk)
L—p (or pos), n (or neg)
V—p (or pos), n (or neg)
   where MOS types include M, MD, ME, MN, MP, LDD, LDDE, LDDD, LDDN, and LDDP.

If netlist transformation is performed, then the programmable electrical rule check tool also recognizes the logic gates and/or logic injections formed by a conventional layout-versus-schematic (LVS) verification tool. These are also considered as built-in devices with built-in pins. A list of sample logic gates and logic injection devices with their corresponding built-in pins that may be employed by various implementations of a programmable electrical rule check tool according to various embodiments of the invention is as follows:
INV—output input
NAND2—output input input
NOR3—output input input input
_invv—out in
_nand2v—out in1 in2
_smp3v out1 out2 in1 in2 in3

Besides the individual device types, implementations of a programmable electrical rule check tool according to various embodiments of the invention may also provide four reserved keywords for referencing generic logic gates and logic injection devices:
lvsGate—device type referring to all logic gates
lvsInjection—device type referring to all logic injection devices
lvsIn—pin name referring to all input pins of logic gates and gate-based injection devices.
lvsOut—pin name referring to all output pins of logic gates and gate-based injection devices.

With some implementations of a programmable electrical rule check tool according to various embodiments of the invention, all commands may reside in the “perc::” name space. As a general rule, a mandatory command argument is specified at its fixed location, while an optional argument uses a switch starting with ‘-’. However, for commands with many arguments, even mandatory arguments may use switches for text clarity.

The following sections discuss the commands that may be provided by an example of a programmable electrical rule check tool that may be implemented according to various embodiments of the invention.

### Initialization Commands

To facilitate electrical rule checking, the programmable electrical rule check tool allows the user to initialize the netlist before executing any rule checks. There are two kinds of initialization commands supported:
Net type commands—used to label nets with net types
Net path commands—used to create net paths across devices

When processing a new COMMAND5 statement, the programmable electrical rule check tool first removes all existing net types and net paths. If the COMMAND5 statement does not specify the optional initialization procedure, then no net has net types, and there are no non-trivial net paths. However, if net types and/or net paths are created in the initialization procedure, they are valid until all of the rule checks in the statement are executed.

The Creating Net Types by Net Names Command:
perc::commanda <net_type> <net_name_list> [-cell|-cellName <cell_name list>]

This command creates a new net type or reuses an existing net type, and assigns the net type to nets with certain names. The required argument <net_type> specifies the type name, and must be a nonempty string. This command can be called any number of times in a single initialization procedure, but the total number of unique net types must not exceed 64 according to various embodiments of the invention.

The required argument <net_name_list> must be a Tcl list consisting of one or more net names. Each net name can contain one or more question mark(?) characters. The ? is a wildcard character that matches zero or more characters. The net names in this list must be well-formed, i.e. net names classified as non-user-given names should not appear in this list.

The optional -cell switch controls the propagation of the net type from lower level cells. If -cell is not specified, the programmable electrical rule check tool only assigns <net_type> to nets in the top cell whose name matches the settings of <net_name_list>. The programmable electrical rule check tool then propagates <net_type> down the hierarchy to any nets attached to them through ports. However, if -cell is specified, the programmable electrical rule check tool assigns <net_type> to nets in all lower level cells as well as the top cell whose name matches the settings of <net_name_list>. Moreover, the programmable electrical rule check tool propagates <net_type> up and down the hierarchy into any nets attached to them through ports. Upward propagation occurs first. Propagation of <net_type> through the hierarchy continues to a net's top level. For downward propagation, top-level nets which receive <net_type> through upward propagation are treated in the same way as nets assigned the <net_type> at the top level.

The optional -cellName switch is similar to the -cell switch, but only assigns <net_type> to nets in selected cells, not all cells. <cell_name_list> must be a Tcl list consisting of one or more cell names, and starting with possibly the exclamation symbol (!), such as “cell_1 cell_2” or “! cell_3 cell_4”. If the exclamation symbol is not present, then only cells with these names can be selected. However, if the exclamation symbol is specified, then only cells with names other than those listed can be selected. The top-level cell is not automatically selected, its name has to be listed in <cell_name_list> in order for it to be selected. However, the programmable electrical rule check tool provides a reserved keyword for referencing the top-level cell:
lvsTop—generic cell name referring to the top-level cell

Only one of the two switches, -cell and -cellName, can be specified for one net type, not both. A user will employ the -cell option to propagate a net type from all cells, and employ the -cellName option to propagate a net type from a list of cells. Moreover, if a net type is defined using multiple command calls, the -cell or -cellName option can be specified at most once, because these options have to be consistent (same) in all of the calls for the same net type.

Nets that receive <net_type> are said to have the named net type. A net can have multiple net types. This happens when a net appears in multiple perc::commanda (or perc::commanda+) command calls, or because of net type propagation.

No net types are assumed by default, so a specific command (perc::commanda+, discussed in more detail below) must be called to create any net type. In particular, the power/ground nets declared in LVS do not automatically have any net types. However, the programmable electrical rule check tool provides three reserved keywords for referencing some special nets in a related layout-versus-schematic operation:
lvsPower—the list of power nets
lvsGround—the list of ground nets
lvsOutline—the list of external nets in the top cell

These keywords can be used in the argument <net_name_list>, just like regular net names. The programmable electrical rule check tool automatically expands them into the list of nets they represent.

<net_type> is case sensitive if the COMMAND10 specification statement has been specified with the YES or TYPES parameter.

This command returns nothing. Examples of the use of this command are listed below:

COMMAND11 VDD? VCC?
COMMAND4 test [/*
proc init_1 { } {

| | |
|---|---|
| perc::commanda generic_power | {VDD? VCC?} |
| } | |
| proc init_2 { } { | |
| perc::commanda generic_power | {lvsPower} |
| } | |
| proc init_3 { } { | |
| perc::commanda generic_power | {VDD? VCC?} |
| perc::commanda vdd_power | {VDD?} |
| perc::commanda vcc_power | {VCC?} |
| perc::commanda 2_v_5_power | {VDD_2_V_5 VCC_2_V_5} |
| } | |
| proc init_4 { } { | |

| | | |
|---|---|---|
| perc::commanda power | {VDD?} | |
| perc::commanda pad | {PAD} | -cell |
| perc::commanda output | {Z} | -cellName {std_cell_1 |
| | | std_cell_2} |
| } | | |
| */] | | |

Tcl proc init_1 creates a net type called generic_power. Any net with name starting with VDD or VCC in the top cell has this net type. Tcl proc init_2 is the same as init_1, but uses the lvsPower keyword. Tcl proc init_3 creates four net types: generic_power, vdd_power, vcc_power, and 2_v_{—}5_power. Any net with name starting with VDD or VCC in the top cell has the type generic_power. Only nets with name starting with VDD in the top cell have the type vdd_power. Similarly, only nets with name starting with VCC in the top cell have the type vcc_power. Finally, only nets named VDD_2_V_5 or VCC_2_V_5 in the top cell have the type 2_v_{—}5_power. This example shows that a net can have multiple net types. For instance, net VDD_2_V_5 has three types: generic_power, vdd_power, and 2_v_{—}5_power. Tcl proc init_4 creates three net types: power, pad, and output. Any net with name starting with VDD in the top cell has the type power. However, since net type pad is specified with -cell, any net named PAD at any level of the hierarchy has the type pad. Net type output is more restrictive, only nets named Z in cells std cell_1 and std cell_2 at any level of the hierarchy have the type output.

The Creating Net Types by Devices Command:

perc::commanda+ <net_type> -type <device_type_list>

[-subtype <subtype_list>]
[-property <constraint>]
[-pin <pin_name_list>]
[-cell | -cellName <cell_name_list>]

This command creates a new net type or reuses an existing net type, and assigns the net type to nets connected to devices selected according to conditions specified by the switches. The required argument <net_type> specifies the name, and must be a nonempty string. This command can be called any number of times in a single initialization procedure, but the total number of unique net types must not exceed 64 with some implementations of the programmable electrical rule check tool.

The required -type switch specifies a list of device types used in the definition of net type. <device_type_list> must be a Tcl list consisting of one or more device types. A device must have one of the listed types in order to be selected.

The optional -subtype switch specifies device models. <subtype_list> must be a Tcl list consisting of one or more device models, and starting with possibly the exclamation symbol (!), such as “model_1 model_2” or “! model_3 model_4”. If the exclamation symbol is not present, then only devices with these models can be selected. However, if the exclamation symbol is specified, then only devices with models other than those listed can be selected.

The optional -property switch specifies a device property condition to further limit the devices that can be selected. The <constraint> value must be a nonempty string specifying a property name followed by a constraint limiting the value of the property. Only devices satisfying <constraint> can be selected. Specifically, the following list shows all of the valid expressions for specifying constraints (P is some property name, while a and b are some constants):
P<a
P>a
P<=a
P>=a
P==a
P!=a
P>a<b
P>=a<b
P>a<=b
P>=a<=b

The optional -pin switch specifies device pins that can be selected. <pin_name_list> must be a Tcl list consisting of one or more pin names that belong to the device types. If this switch is not used, the programmable electrical rule check tool selects all pins by default. The programmable electrical rule check tool only assigns <net_type> to nets connected to the selected pins of the selected devices.

The optional -cell switch controls the propagation of the net type from lower level cells. If -cell is not specified, the programmable electrical rule check tool only assigns <net_type> to nets in the top cell that are connected to the selected devices. A programmable electrical rule check tool according to various embodiments of the invention may then propagate <net_type> down the hierarchy to any nets attached to them through ports. However, if -cell is specified, the programmable electrical rule check tool assigns <net_type> to nets in lower level cells as well as the top cell that are connected to the selected devices. Moreover, the programmable electrical rule check tool propagates <net_type> up and down the hierarchy into any nets attached to them through ports. Upward propagation occurs first. Propagation of <net_type> through the hierarchy continues to a net's top level. For downward propagation, top-level nets which receive <net_type> through upward propagation are treated in the same way as nets assigned the <net_type> at the top level.

The optional -cellName switch is similar to the -cell switch, but only assigns <net_type> to nets in selected cells, not all cells. <cell_name_list> must be a Tcl list consisting of one or more cell names, and starting with possibly the exclamation symbol (!), such as “cell_1 cell_2” or “! cell_3 cell_4”. If the exclamation symbol is not present, then only cells with these names can be selected. However, if the exclamation symbol is specified, then only cells with names other than those listed can be selected. The top-level cell is not automatically selected, its name has to be listed in <cell_name_list> in order for it to be selected. However, the programmable electrical rule check tool provides a reserved keyword for referencing the top-level cell:
lvsTop—generic cell name referring to the top-level cell

Only one of the two switches, -cell and -cellName, can be specified for one net type, not both. Use -cell to propagate a net type from all cells, and use -cellName to propagate a net type from a list of cells. Moreover, if a net type is defined using multiple command calls, the -cell or -cellName option can be specified at most once, because these options have to be consistent (same) in all of the calls for the same net type.

Nets that receive <net_type> are said to have the named net type. A net can have multiple net types. This happens when a net appears in multiple perc::commanda+ (or perc::commanda) command calls, or because of net type propagation.

No net types are assumed by default, so this command (or perc::commanda) must be called to create any net type.

<Net type> is case sensitive if the COMMAND10 specification statement has been specified with the YES or TYPES parameter.

This command returns nothing. Examples of the use of this command are listed below:

```
COMMAND4 test [/*
  proc init_1 { } {
    perc::commanda+ “label_a” -type {R} -subtype {ar} -pin {p n}
    perc::commanda+ “label_b” -type {R} -property {r < 100}
    perc::commanda+ “label_c” -type {R} -subtype {! ar br} -cell
  }
*/]
```

Tcl proc init_1 creates three net types: label_a, label_b, and label_c. Any net connected to a resistor of model ‘ar’ through the positive or negative pin in the top cell has the type label_a. Any net connected to any resistor with value less than 100 in the top cell has the type label_b. However, since net type label_c is specified with -cell, any net connected to a resistor of model other than ‘ar’ or ‘br’ at any level of the hierarchy has the type label_c.

The Creating Net Type Sets Command:
perc::commandb <type_set> <net_type_list>

This command creates a new net type set. The required argument <type_set> specifies the name, and must be a nonempty string. With some implementation of a programmable electrical rule check tool according to various embodiments of the invention, this command can be called up to 64 times in a single initialization procedure, but each type set must have a unique name. Moreover, no type set can share a name with any net type.

The required argument <net_type_list> must be a Tcl list consisting of one or more net types. The newly created <type_set> simply acts as a shorthand notation for the list of net types. A net is said to have the type named <type_set> if the net has at least one net type contained in <net_type_list>. In other words, a type set represents the logical OR relation. A type set can be used in rule checking wherever net types are expected. Naturally, a type set can also appear in the argument <net_type_list> in this command. No net type set is assumed by default, so this command must be called to create any net type set.

<type_set> is case sensitive if the COMMAND10 specification statement has been specified with the YES or TYPES parameter. Net types in <net_type_list> are case sensitive if the COMMAND10 specification statement has been specified with the YES or TYPES parameter.

This command returns nothing. Examples of the use of this command are listed below:

| | |
|---|---|
| COMMAND4 test [/* | |
| proc init { } { | |
| perc::commanda vdd_power | {VDD?} |
| perc::commanda vcc_power | {VCC?} -cell |
| perc::commanda ground | {VSS? GND} |
| perc::commandb generic_power | {vdd_power vcc_power} |
| perc::commandb supply | {generic_power ground} |
| } | |
| */] | |

Tcl proc init creates three net types: vdd_power, vcc_power, and ground. It then creates a type set called generic_power. Any net with name starting with VDD in the top cell or with name starting with VCC at any level of the hierarchy has the type generic_power. Finally, it creates a type set called supply. Any net having type vdd_power, or vcc_power, or ground also has the type supply. Note that the type set supply is built upon type set generic_power.

The Creating Net Paths Command:

```
perc::commandc -type <device_type_list>
    [-subtype <device_subtype_list>]
    [-property <constraint>]
    [-pin <pin_name_list>]
    [-break <net_type_condition_list> [-exclude <net_type_list>] ]
```

This command establishes net paths that lead through pins of devices. The required -type switch specifies a list of device types used in the definition of path. <device_type_list> must be a Tcl list consisting of one or more device types.

The optional -subtype switch specifies device models. <device_subtype_list> must be a Tcl list consisting of one or more device models, and starting with possibly the exclamation symbol (!), such as “model_1 model_2” or “! model_3 model_4”. If the exclamation symbol is not present, then only devices with these models can be part of a path. However, if the exclamation symbol is specified, then only devices with models other than those listed can be part of a path.

The optional -property switch specifies a device property condition to further limit the devices that can be part of a path. <constraint> must be a nonempty string specifying a property name followed by a constraint limiting the value of the property. Only devices satisfying <constraint> can be used to form a path. The notation for <constraint> is the same as that of COMMAND12. Specifically, the following list shows all of the valid expressions for specifying constraints (P is some property name, while a and b are some constants):
P<a
P>a
P<=a
P>=a
P==a
P!=a
P>a<b
P>=a<b
P>a<=b
P>=a<=b

The optional -pin switch specifies device pins that a path goes through. <pin_name_list> must be a Tcl list consisting of two or more pin names that belong to the device types. If this switch is not used, the programmable electrical rule check tool chooses all pins by default.

The optional -break switch controls where a path stops. If -break is not specified, which is the default, a path continues until it reaches an unqualified device or a port in the top cell. If -break is specified, then a path also stops when it reaches a net that meets the criteria of <net_type_condition_list>. The argument <net_type_condition_list> must be a Tcl list consisting of one or more net types, and possibly the exclamation symbol (!), such as {net_type_1 net_type_2 ! net_type_3}. A net is said to meet the condition if the net has all of the net types before the exclamation symbol, and the net does not have any of the net types after the exclamation symbol.

Even though a break net is not part of a path, its net types contribute to the combined net types of the path. By default, a path has the combined net types from all of the nets in the path, plus the net types of its break nets. The optional -exclude switch controls the net types that a break net can contribute to a path. <net_type_list> must be a Tcl list consisting of one or more net types. If -exclude is specified, then a path does not receive the net types listed in <net_type_list> from its break nets. However, a path can still carry the net types listed in <net_type_list> if any net of the path has those net types.

This command can be called any number of times in a single initialization procedure. A programmable electrical rule check tool according to various embodiments of the invention will accumulate the conditions specified in each call, and create paths using the combined path definition. However, the -break option and its secondary -exclude option can be specified at most once, because these options have to be consistent (same) in all of the calls.

Each net in the netlist belongs to one and only one path. If this command is not called at all, then each net belongs to a trivial path, which is the path consisting of the net itself. This command must be called to create non-trivial paths.

This command returns nothing. Examples of the use of this command are listed below:

```
  COMMAND4 test [/*
    proc init_1 { } {
      perc::commandc -type {M MD ME MN MP LDD LDDE LDDD
LDDN LDDP} - pin {s d}
      perc::commandc -type {R} -pin {pos neg}
    }
    proc init_2 { } {
      perc::commandc -type {M MD ME MN MP LDD LDDE LDDD
      LDDN LDDP R }
    }
    proc init_3 { } {
      perc::commandc -type UDP -pin {plus minus}
    }
    proc init_4 { } {
      perc::commandc -type R -property “r < 10” -pin {p n}
    }
    proc init_5 { } {
```

| | |
|---|---|
| perc::commanda power | {VDD?} |
| perc::commanda ground | {VSS?} |

```
      perc::commandc -type {MP MN} -pin {s d} -break {power
ground} - exclude power
    }
    proc init_6 { } {
```

| | |
|---|---|
| perc::commanda power | {VDD?} |
| perc::commanda ground | {VSS?} |
| perc::commandb supply | {power ground} |

```
      perc::commandc -type {R} -pin {p n} -break supply -exclude
{power ground}
    }
  */]
```

Tcl proc init_1 creates paths that lead through source/drain pins of MOS, and positive/negative pins of resistor devices. This is usually the default path definition in LVS. Tcl proc init_2 creates paths that lead through all pins of MOS, and all pins of resistor devices. Tcl proc init_3 creates paths that lead through plus/minus pins of UDP devices. Tcl proc init_4 creates paths that lead through positive/negative pins of resistors with resistance less than 10. Tcl proc init_5 creates paths that lead through source/drain pins of MOS devices. A net having both types power and ground breaks a path, though the path still carries the net's types, excluding power. Tcl proc init_6 creates paths that lead through positive/negative pins of resistors. A net having type ground or power breaks a path, though the path still carries the net's types, other than power and ground. This example shows that you have to define a net type set to specify several break nets (the OR logical relation).

When processing each COMMAND5 statement, the programmable electrical rule check tool initializes the netlist before executing any rule checks selected by the statement. As the last part of the initialization phase, the programmable electrical rule check tool computes cell placement signatures for every hcell in the design. If the optional initialization Tcl proc is specified, the programmable electrical rule check tool executes the Tcl proc first before computing placement signatures.

For any cell, its placement signature consists of four lists. The size of each list is equal to the number of cell ports. The four lists are:
Net types list—stores the net types of the connecting nets
Net status list—stores the high short status of the connecting nets
Path types list—stores the net types of the connecting paths
Path status list—stores the high short status of the connecting paths

Two placements of the same cell are said to have the same signature if and only if they have the same four lists. With this definition of placement signature, a programmable electrical rule check tool according to various embodiments of the invention guarantees that the commands used for rule checking always yield the same results for different placements of the same cell as long as they have the same signature.

For each cell in the design hierarchy, the programmable electrical rule check tool finds all of its placements and computes their signatures. The programmable electrical rule check tool then collects a list of unique signatures. For each unique signature, the programmable electrical rule check tool picks a placement in the highest level of the design hierarchy as its representative. More specifically, a cell's placement representative consists of three things: the cell itself, the placement signature, and the placement path.

After the computation is done, each cell has a list of placement representatives. Each cell is guaranteed to have at least one placement representative. Later, when checking rules, the programmable electrical rule check tool only examines the representative cell placements, thus improving performance.

It should be appreciated that the commands discussed in this section are for netlist initialization, and, therefore, cannot be used by rule checks. On the other hand, all other commands (to be described later) are intended for rule checking, and thus cannot be used in the initialization procedure.

Since the initialization procedure is a Tcl proc, it follows the Tcl conventions. Order is important. Anything referenced by a command has to be defined before the command is called. In particular, the perc::commanda commands should be called before the first perc::commandb command. And net types/type sets should be defined before the first perc::commandc command.

### Low-Level Rule Checking Commands

The low-level commands do not actually output results to the report file. They primarily provide access to data in the input netlist. These commands rely on the mechanism of iterators. An iterator is an opaque handle in Tcl that points to an element in the input netlist. The supported iterator types are:
Cell iterator—points to a cell
Placement iterator—points to a cell placement representative
Instance iterator—points to a device or cell instance
Net iterator—points to a net
Pin iterator—points to a pin
Property iterator—points to a property of a device

When an iterator is generated to point to the beginning of an ordered list of elements, such as the pin list of a device, it can be stepped forward to go through every element of the list.

The string representation of an iterator is a string of hexadecimal numbers like “bef1fc0”, representing the address of the pointed element. It is guaranteed to be unique, so two different iterators are pointing to the same element in the netlist if and only if they are equal as strings. When an iterator is stepped forward and reaches the end of its list, its string representation is set to the empty string.

This section discusses commands for generating, accessing, and stepping through iterators.

### The Generating Cell Iterators Command:

perc::commandd [-topDown]

By default, this command creates an iterator pointing to the first cell of the list of all hcells in the design hierarchy sorted in the bottom-up order. The optional switch -topDown changes the sorting order to top-down. The created iterator can be stepped forward to access all cells in a design.

This command returns the created cell iterator. Examples of the use of this command are listed below:

```
COMMAND4 test [/*
  proc demo { } {
    set cellItr_1 [perc::commandd]
    set cellItr_2 [perc::commandd -topDown]
    if { $cellItr_1 eq $cellItr_2 } {
      puts “The two iterators are pointing to the same cell”
    }
  }
*/]
```

Tcl proc demo creates two iterators stored in variables cellItr_1 and cellItr_2. cellItr_1 traverses the design hierarchy in bottom-up order, while cellItr_2 traverses in top-down order.

The Generating Cell Placement Representative Iterators Command:
perc::commande <iterator>

If the required argument <iterator> is a cell iterator, this command creates an iterator pointing to the first entry of that cell's list of placement representatives. The created iterator can be stepped forward to access all of the cell's placement representatives. The order of the placement list is neither meaningful nor predictable.

However, if <iterator> points to something other than a cell, such as a net or an instance, then this command creates an iterator pointing to the same cell placement representative that contains the element pointed to by <iterator>. In this case, the created iterator cannot be stepped forward.

This command returns the created placement iterator. Examples of the use of this command are listed below:

```
COMMAND4 test [/*
  proc demo { } {
    set cellItr [perc::commandd]
    set placementItr [perc::commande $cellItr]
  }
*/]
```

Tcl proc demo creates two iterators stored in variables cellItr and placementItr. cellItr points to the bottom cell of the design. placementItr points to the first placement representative of the bottom cell, and can be used to traverse all of the unique placement representatives of the bottom cell.

The Generating Net Iterators Command:
perc::commandf {<placement_iterator>|<pin_iterator>}

This command takes one argument that must be either a placement iterator or a pin iterator. If the required argument is <placement_iterator>, this command creates an iterator pointing to the first entry of the list of all nets contained in the referenced cell placement. The created iterator can be stepped forward to access all nets in the cell placement. The order of the net list is neither meaningful nor predictable.

However, if the required argument is <pin_iterator>, then this command creates an iterator pointing to the net connected to the referenced pin. In this case, the created iterator cannot be stepped forward.

Note that a cell iterator is not a valid argument. A cell by itself does not have all the necessary information about nets, such as net types and net connections. Net iterators can only exist in the context of a cell placement. If the passed-in argument is a pin iterator, then the created net iterator inherits its context from the pin iterator.

This command returns the created net iterator. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set netItr | [perc::commandf $placementItr] |
| } | |
| */] | |

Tcl proc demo creates three iterators stored in variables cellItr, placementItr, and netItr. cellItr points to the top cell of the design. placementItr points to the first placement representative of the top cell. And netItr points to the first net in the top cell. netItr can be used to traverse all of the nets in the top cell.

The Generating Instance Iterators Command:

perc::commandg {<placement_iterator>|<pin_iterator>}

This command takes one argument that must be either a placement iterator or a pin iterator. If the required argument is <placement_iterator>, this command creates an iterator pointing to the first entry of the list of all instances contained in the referenced cell placement. Instances include both primitive devices and sub-cell instances. The created iterator can be stepped forward to access all instances in the cell placement. The order of the instance list is neither meaningful nor predictable. However, if the required argument is <pin_iterator>, then this command creates an iterator pointing to the instance that owns the referenced pin. In this case, the created iterator cannot be stepped forward.

It should be noted that a cell iterator is not a valid argument. A cell by itself does not have all the necessary information about nets, such as net types and net connections. Instance iterators can only exist in the context of a cell placement. If the passed-in argument is a pin iterator, then the created instance iterator inherits its context from the pin iterator.

This command returns the created instance iterator. Examples of the use of this command are listed below:

| COMMAND4 test [/* | |
|---|---|
| proc demo { } { | |
| set cellItr | [perc::commandd -topDown] |
| set placementItr | [perc::commande $cellItr] |
| set insItr | [perc::commandg $placementItr] |
| } | |
| */] | |

Tcl proc demo creates three iterators stored in variables cellItr, placementItr, and insItr. cellItr points to the top cell of the design. placementItr points to the first placement representative of the top cell. And insItr points to the first instance in the top cell. insItr can be used to traverse all of the instances in the top cell.

The Generating Pin Iterators Command:
perc::commandh {{<instance_iterator> [-name <pin_name>]} |<net iterator>}

The required argument must be either an instance iterator or a net iterator. If the argument is <instance_iterator>, this command creates an iterator pointing to the first entry of the referenced instance's pin list. The created iterator can be stepped forward to access all pins of the instance. The order of the pin list is not meaningful, but predictable. For example, “G S D B” is the order for MOS devices, and “P N” is the order for resistors, capacitors, and diodes. If the optional -name switch is specified, then the created iterator points to the pin named <pin_name>, instead of the first instance pin. In this case, the iterator cannot be stepped forward. However, if the required argument is <net_iterator>, then this command creates an iterator pointing to the first entry in the list of all pins connected to the referenced net. The created iterator can be stepped forward to access all pins along the net. The order of the pin list is neither meaningful nor predictable.

A pin iterator inherits its context from the passed-in argument. Pin iterators can only exist in the context of a cell placement.

This command returns the created pin iterator. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set insPinItr | [perc::commandh$insItr -name gate] |
| set netItr | [perc::commandf $insPinItr] |
| set netItr2 | [perc::commandf $placementItr] |
| set netPinItr | [perc::commandh$netItr2] |
| set insItr2 | [perc::commandg $netPinItr] |
| } | |
| */] | |

Pins in a netlist represent cross points between nets and instances. Tcl proc demo demonstrates some of that. insItr points to the first instance in the top cell. insPinItr is created from this instance and points to the pin named gate. netItr is created from insPinItr, and points to the net that is connected to the pin gate.

Similarly, netItr2 points to the first net in the top cell. netPinItr is created from this net and points to the first pin along the net. insItr2 is created from netPinItr, and points to the instance that owns the pin, which implies that the instance is connected to the first net through the pin.

The Generating Property Iterators Command:
perc::commandi <instance_iterator> [-name <property_name>]

The required argument <instance_iterator> must be an instance iterator. This command creates an iterator pointing to the first entry of the referenced instance's property list. The created iterator can be stepped forward to access all properties of the instance, including string properties. The order of the property list is neither meaningful nor predictable.

If the optional switch -name is specified, then the created iterator points to the property named <property_name> instead of the first property. In this case, the iterator cannot be stepped forward.

If the required argument <instance_iterator> happens to point to a sub-cell instance, then the property list is empty, and the created iterator points to the end right away. The same is true for devices without properties.

A property iterator inherits its context from the passed-in argument. Property iterators can only exist in the context of a cell placement.

This command returns the created property iterator. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set propItr | [perc::commandi $insItr] |
| } | |
| */] | |

Tcl proc demo creates an instance iterator called insItr that points to the first instance in the top cell. propItr is created from insItr. propItr points to the first property, and can be used to traverse all properties of the first instance in the top cell.

The Generating Descending Iterators Command:
perc::commandj {<instance_iterator>|<pin_iterator>}

This command takes one argument that must be either an instance iterator or a pin iterator. Moreover, the instance iterator must point to a sub-cell instance, and the pin iterator must point to a pin that belongs to a sub-cell instance.

If the required argument is <instance_iterator>, this command creates an iterator pointing to the sub-cell's placement representative that shares the same placement signature as the referenced sub-cell instance. The created placement iterator cannot be stepped forward.

If the argument is <pin_iterator>, there are several steps involved to create a new iterator. First, the programmable electrical rule check tool finds the sub-cell instance that owns the referenced pin. Second, the programmable electrical rule check tool finds the sub-cell's placement representative that shares the same placement signature as the sub-cell instance. Third, the programmable electrical rule check tool finds the sub-cell's port to which the referenced pin is connected. Fourth, the programmable electrical rule check tool finds the net inside the sub-cell that is connected to the same port. Finally, the programmable electrical rule check tool creates an iterator pointing to the net in the context of the sub-cell placement representative found in the second step. The created net iterator cannot be stepped forward.

This command returns the created placement iterator or net iterator. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set placementItr2 | [perc::commandj $insItr] |
| set netItr | [perc::commandf $placementItr] |
| set pinItr | [perc::commandh$netItr] |
| set netItr2 | [perc::commandj $pinItr] |
| } | |
| */] | |

Tcl proc demo creates an instance iterator called insItr that points to the first instance in the top cell. Assume this instance is a sub-cell instance. placementItr2 is created from this instance and points to the sub-cell's placement representative that shares the same signature as the first instance.

Similarly, netItr points to the first net in the top cell. pinItr is created from this net and points to the first pin along the net. Assume this pin belongs to a sub-cell instance. netItr2 is created from pinItr, and points to the net inside the sub-cell that is connected to the pin through a common port.

The Incrementing Iterators Command:
perc::commandk <iterator>

This command takes one argument that must be an iterator. If the required argument <iterator> points to an entry in a list of elements, this command increments the iterator to point to the next entry. Whether an iterator can be stepped forward using this command is determined by how the iterator is generated, as discussed in previous subsections. It is an error to call this command on any iterator that points to a single element.

It should be noted that the argument <iterator> should not use the $ char when referencing a variable, because what is of interest here is the name of the iterator, not the element pointed to by the iterator. A more precise notation for the argument might be <iterator_variable_name>.

This command returns nothing. Examples of the use of this command are listed below:

```
COMMAND4 test [/*
  proc demo { } {
    set cell [perc::commandd]
    while {$cell ne “”} {
      perc::commandk cell
    }
  }
*/]
```

Tcl proc demo basically walks through the list of all cells in the design in bottom-up order. It checks the string representation of the iterator to determine whether the end is reached. Note that there is no $ char before the variable cell in the call to perc::commandk.

The Accessing Element Names Command:
perc::commandl <iterator>

This command takes one required argument that must be an iterator. It returns the name of the element pointed to by <iterator>. The name returned depends on the type of the iterator:
Cell iterator—returns the cell name
Placement iterator—returns the cell name
Instance iterator—returns the instance name
Net iterator—returns the net name
Pin iterator—returns the pin name
Property iterator—returns the property name

This command returns a string. Examples of the use of this command are listed below:

```
COMMAND4 test [/*
  proc demo { } {
    set cell [perc::commandd -topDown]
    set top  [perc::commandl $cell]
  }
*/]
```

In the Tcl proc demo, the variable top is assigned the name of the top cell.

The Accessing Element Types Command:
perc::commandm {<instance_iterator>|{{<net_iterator>|<pin_iterator>} [-path]}}

This command takes a required argument that must be one of the following: an instance iterator, a net iterator, or a pin iterator. If the required argument is <instance_iterator>, this command returns the type of the referenced instance. For a primitive device, it returns its device type, such as MN, MP, or R. For a sub-cell instance, it returns its cell name.

If the required argument is <net_iterator>, the optional switch -path can be used. If -path is not specified, this command returns the net types assigned to the referenced net. If -path is present, this command returns the net types carried by the net's path. Since a net may have multiple net types or path types, the return value is a Tcl list. For a net without any net type or path type, it returns the empty list.

If the required argument is <pin_iterator>, the optional switch -path can be used. If -path is not specified, this command returns the net types assigned to the net connected to the referenced pin. If -path is present, this command returns the net types carried by the pin's path. It also returns a Tcl list same as in the case for <net_iterator>.

This command returns a string (instance type) or a list of strings (net/path types for a net or pin). Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set insType | [perc::commandm $insItr] |
| set netItr | [perc::commandf $placementItr] |
| set netTypes | [perc::commandm $netItr] |
| } | |
| */] | |

Tcl proc demo creates an instance iterator called insItr that points to the first instance in the top cell. The variable insType is assigned the type of the first instance.

Similarly, netItr points to the first net in the top cell. The variable netTypes is a Tcl list that holds the net types assigned to that net.

The Accessing Instance Subtypes Command:
perc::commandn <instance_iterator>

This command takes one argument that must be an instance iterator. If the required argument <instance_iterator> points to a primitive device, it returns its device subtype, which may be the empty string. For a sub-cell instance, it always returns the empty string.

This command returns a string. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set insSubtype | [perc::commandn $insItr] |
| } | |
| */] | |

Tcl proc demo creates an instance iterator called insItr that points to the first instance in the top cell. The variable insSubtype is assigned the subtype of the first instance.

The Accessing Instance Properties Command:
perc::commando <instance_iterator> <property_name>
perc::commandp <property_iterator>

The perc::commando command takes two required arguments: an instance iterator and a property name. If the argument <instance_iterator> points to a primitive device that has the property named <property_name>, this command returns the property value. Otherwise, the named property is deemed missing, and this command results in an error.

The perc::commandp command takes one required argument that must be a property iterator. If the device property referenced by <property_iterator> exists, this command returns the property value. Otherwise, the property is deemed missing, and this command returns the value NaN (i.e., “Not a Number”). It should be noted that this command does not result in an error if the property value is missing.

These two commands return a float number for a numeric property, and a string for a string-type property. Examples of the use of these commands are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |
| set width | [perc::commando $insItr W] |
| set propertyItr | [perc::commandi $insItr -name W] |
| set width2 | [perc::commandp $propertyItr] |
| } | |
| */] | |

Tcl proc demo creates an instance iterator called insItr that points to the first instance in the top cell. Assume this instance is a MOS device. The variable width is assigned the value of property W of the first instance by calling the command perc::commando. Similarly, the variable width2 is assigned the same property value. But this time, the command perc::commandp is invoked.

The Checking Sub-Cell Instances Command:
perc::commandq <instance_iterator>

This command takes one required argument that must be an instance iterator. If the argument <instance iterator> points to a sub-cell instance, it returns 1. Otherwise, it returns 0.

This command returns an integer. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set insItr | [perc::commandg $placementItr] |

```
    if {[perc::commandq $insItr]} {
        set sub_cell [perc::commandj $insItr]
    }
  }
*/]
```

Tcl proc demo creates an instance iterator called insItr that points to the first instance in the top cell. If the instance is a sub-cell instance, it then goes down the hierarchy and gets to the sub-cell.

The Checking External Nets Command:
perc::commandr <net_iterator>

This command takes one required argument that must be a net iterator. If the argument <net_iterator> points to a net that is connected to a cell port, it returns 1. Otherwise, it returns 0.

This command returns an integer. Examples of the use of this command are listed below:

| | |
|---|---|
| COMMAND4 test [/* | |
| proc demo { } { | |
| set cellItr | [perc::commandd -topDown] |
| set placementItr | [perc::commande $cellItr] |
| set netItr | [perc::commandf $placementItr] |

```
    set outline [perc::commandr $netItr]
  }
*/]
```

Tcl proc demo creates a net iterator called netItr that points to the first net in the top cell. The variable outline is assigned the value of 1 if the net is connected to a port, 0 otherwise.

The Checking Instance Pin's Net Connections Command:
perc::commands <instance_iterator> <pin_name_list>

The required argument <instance_iterator> must be an instance iterator, and the required argument <pin_name_list> must be a Tcl list consisting of one or more valid pin names. This command returns the number of different nets connected to the listed pins of the referenced instance. Two nets that are different within the cell but are connected at a higher level are considered the same net. In other words, this command computes the flat net count.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |

```
    set net_count [perc::commands $insItr {G S D}]
  }
*/]
```

Tcl proc demo creates an instance iterator called insItr that points to the first instance in the bottom cell. Assume the instance is a MOS device. The variable net_count is assigned the number of different nets connected to the gate, source, and drain pins of the MOS device, in the context of the first placement representative of the bottom cell.

The Checking Instance Pin's Path Connections Command:
perc::commandt <instance_iterator> <pin_name_list>

The required argument <instance_iterator> must be an instance iterator, and the required argument <pin_name_list> must be a Tcl list consisting of one or more valid pin names. This command returns the number of different paths connected to the listed pins of the referenced instance. Two paths that are different within the cell but are connected at a higher level are considered the same path. In other words, this command computes the flat path count.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |

```
    set path_count [perc::commandt $insItr {G S D}]
  }
*/]
```

Tcl proc demo creates an instance iterator called insItr that points to the first instance in the bottom cell. If, for example, it is assumed that the instance is a MOS device, then the variable path_count is assigned the number of different paths connected to the gate, source, and drain pins of the MOS device, in the context of the first placement representative of the bottom cell.

The Checking Instance Pins' Net Types Command:
perc::commandu <instance_iterator> <pin_name_list> <net_type_condition_list>

The required argument <instance_iterator> must be an instance iterator, and the required argument <pin_name_list> must be a Tcl list consisting of one or more pin names. This command checks the net types of the nets connected to the listed pins of the referenced instance. If there is at least one net that meets the criteria specified by the <net_type_condition_list> argument, the command returns the value of 1. Otherwise, it returns the value of 0.

The required argument <net_type_condition_list> must be a Tcl list consisting of one or more net types, and possibly the exclamation symbol (!), such as {net_type_1 net_type_2 ! net_type_3}. A net is said to meet the condition if the net has all of the net types before the exclamation symbol, and the net does not have any of the net types after the exclamation symbol.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |

```
    set power_only [perc::commandu $insItr {S D} {power ! ground}]
  }
*/]
```

Tcl proc demo creates an instance iterator called insItr that points to the first instance in the bottom cell. If, for example, it is assumed that the instance is a MOS device, then, of the two nets connected to the source/drain pins of the MOS device, if there is at least one net that carries the net type power and does not carry the net type ground in the context of the first placement representative of the bottom cell, the variable power_only is assigned the value of 1. Otherwise, the variable equals to 0.

The Checking Instance Pins' Path Types Command:
perc::commandv <instance_iterator> <pin_name_list> <path_type_condition_list>

The required argument <instance_iterator> must be an instance iterator, and the required argument <pin_name_list> must be a Tcl list consisting of one or more pin names. This command checks the net types of the paths connected to the listed pins of the referenced instance. If there is at least one path that meets the criteria specified by the <path_type_condition_list> argument, the command returns the value of 1. Otherwise, it returns the value of 0.

The required argument <path_type_condition_list> must be a Tcl list consisting of one or more net types, and possibly the exclamation symbol (!). A path is said to meet the condition if the path has all of the net types before the exclamation symbol, and the path does not have any of the net types after the exclamation symbol.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |

```
    set no_pad [perc::commandv $insItr {G S D} {! PAD}]
  }
*/]
```

Tcl proc demo creates an instance iterator called insItr that points to the first instance in the bottom cell. If, for example, it is assumed that the instance is a MOS device, then, of the two paths connected to the gate pin and the source/drain pins of the MOS device, if there is at least one path that does not carry the net type PAD, in the context of the first placement representative of the bottom cell, the variable no_pad is assigned the value of 1. Otherwise, the variable equals to 0.

The Checking Nets' Net Types Command:
perc::commandw <net_iterator> <net_type_condition_list>

The required argument <net_iterator> must be a net iterator. This command checks the net types of the referenced net. If the net meets the criteria specified by the <net_type_condition_list> argument, the command returns the value of 1. Otherwise, it returns the value of 0.

The required argument <net_type_condition_list> must be a Tcl list consisting of one or more net types, and possibly the exclamation symbol (!). A net is said to meet the condition if the net has all of the net types before the exclamation symbol, and the net does not have any of the net types after the exclamation symbol.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set netItr | [perc::commandf $placementItr] |

```
    set short [perc::commandw $netItr {power ground}]
  }
*/]
```

Tcl proc demo creates a net iterator called netItr that points to the first net in the bottom cell. If the net carries both net types power and ground in the context of the first placement representative of the bottom cell, then the variable short is assigned the value of 1. Otherwise, the variable equals to 0.

The Checking Nets' Path Types Command:
perc::commandx <net_iterator> <path_type_condition_list>

The required argument <net_iterator> must be a net iterator. This command checks the net types of the path that contains the referenced net. If the path meets the criteria specified by the <path_type_condition_list> argument, the command returns the value of 1. Otherwise, it returns the value of 0.

The required argument <path_type_condition_list> must be a Tcl list consisting of one or more net types, and possibly the exclamation symbol (!). A path is said to meet the condition if the path has all of the net types before the exclamation symbol, and the path does not have any of the net types after the exclamation symbol.

This command returns an integer. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set netItr | [perc::commandf $placementItr] |

```
    set no_supply [perc::commandx $netItr {! power ground}]
  }
*/]
```

Tcl proc demo creates a net iterator called netItr that points to the first net in the bottom cell. If the net's path carries neither net type power nor ground in the context of the first placement representative of the bottom cell, then the variable no_supply is assigned the value of 1. Otherwise, the variable equals to 0.

The Accessing Series Devices Command:
perc::commandy <instance_iterator> <net_iterator> <pin_1> <pin_2>

All arguments are required. The argument <instance_iterator> must be an instance iterator. The argument <net_iterator> must be a net iterator pointing to a net connected to the device referenced by <instance_iterator>. Furthermore, the net must be connected to the device through the pin named either <pin_1> or <pin_2>. <pin_1> and <pin_2> must be nonempty strings.

This command finds all devices in series. The programmable electrical rule check tool starts from the device pointed to by <instance_iterator>, and searches the next device on the net pointed to by <net_iterator>. If there is only one other device that is connected to the net, the device is of the same type, and the device is connected to the net through the pin named either <pin_1> or <pin_2>, then the series is extended. This next device becomes the new starting device, with its other net connected to <pin_1> or <pin_2> as the new starting net. This process stops if the programmable electrical rule check tool cannot find the proper next device, or the net is connected to a port, or there are more than two devices connected to the net.

This command creates a list of instance iterators to store the devices in series, in the order as they are found. So the first one in the list is always <instance_iterator>. The list is never empty; it contains at least one device.

This command returns a Tcl list consisting of instance iterators. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |
| set pinItr | [perc::commandh$insItr -name S] |
| set netItr | [perc::commandf $pinItr] |
| set series_mos | [perc::commandy $insItr $netItr S D] |
| } | |
| */] | |

Tcl proc demo creates an instance iterator called insItr that points to the first instance in the bottom cell. If, for example, it is assumed that this instance is a MOS transistor, then the variable series_mos is assigned the value of a Tcl list, consisting of all MOS devices connected to the transistor in series, starting from the transistor's source pin.

The Accessing the Other Net of a Device Command:
perc::commandz <instance_iterator> <net_iterator> <pin_1> <pin_2>

All arguments are required. The argument <instance_iterator> must be an instance iterator. The argument <net_iterator> must be a net iterator pointing to a net connected to the device referenced by <instance_iterator>. Furthermore, the net must be connected to the device through the pin named either <pin_1> or <pin_2>. <pin_1> and <pin_2> must be nonempty strings.

This command finds the other net connected to the device pointed to by <instance_iterator> that is not the net referenced by <net_iterator>. Moreover, this other net must be connected to the device through the pin named either <pin_1> or <pin_2>.

This command returns a net iterator pointing to the found net. If the other net is not found, this command returns a net iterator with the empty string representation. Examples of the use of this command are listed below:

| | |
|---|---|
| COMMAND4 test [/* | |
| proc demo { } { | |
| set cellItr | [perc::commandd] |
| set placementItr | [perc::commande $cellItr] |
| set insItr | [perc::commandg $placementItr] |
| set pinItr | [perc::commandh$insItr -name S] |
| set netItr | [perc::commandf $pinItr] |
| set netItr2 | [perc::commandz $insItr $netItr S D] |
| } | |
| */] | |

Tcl proc demo creates an instance iterator called insItr that points to the first instance in the bottom cell. Assume this instance is a MOS transistor. The variable netItr2 points to the net connected to the transistor through the drain pin.

The Comparing Two Iterators Command:
perc::commandaa <iterator_1> <iterator_2>

This command returns the value of 1 if the two required arguments, <iterator_1> and <iterator_2>, are pointing to the same element in the netlist, and returns the value of 0 otherwise.

Nets are compared in the flat sense. Two nets that are different within the cell but are connected at a higher level are considered the same net.

This command returns an integer. Examples of the use of this command are as follows:

| | |
|---|---|
| COMMAND4 test [/* | |
| proc demo { } { | |
| set cellItr | [perc::commandd] |
| set placementItr | [perc::commande $cellItr] |
| set is_same | [perc::commandaa $cellItr $placementItr] |
| } | |
| */] | |

Tcl proc demo compares a cell iterator to a placement iterator. The variable is_same is assigned the value of 0.

High-Level Rule Checking Commands

The high-level commands provide a means to write complex rule checks. There are two basic kinds: rule commands used to define rule checks, and vector commands used to compute parameters over a list of devices.

With various embodiments of the invention, the rule commands are the only the programmable electrical rule check tool commands that output results to the report file. They are:
commandα—defines a rule for checking nets
commandβ—defines a rule for checking devices
commandγ—defines a rule for checking arbitrary data
commandδ—adds user-defined contents to the report file

The vector commands are similar in nature to the vector functions in a conventional layout-versus-schematic (LVS) verification tool reduction property language. They apply some expression to a list of devices and return a value. The vector commands are:
commandε—returns the sum of expression values
commandζ—returns the product of expression values
commandη—returns the minimum of expression values
commandθ—returns the maximum of expression values
commandι—returns the number of devices in the list
commandκ—returns the number of nets/paths connected to the list of devices along a net

The following subsections discuss these commands in detail.

The Net Rule Check Command:

| | |
|---|---|
| perc::commandα | [-netType <net_type_condition_list>] |
| | [-pathType <path_type_condition_list>] |
| | [-condition <cond_proc>] |
| | [-cell] |
| | [-comment <comment>] |

This command checks each net in the design to find the ones that match all of the conditions specified by the optional switches. If a net is a match, the programmable electrical rule check tool outputs the net to the report file as a generated result. Note that the default behavior where no switch is provided is not very useful because every net is a match in that case.

If the optional switch -netType is specified, a net must meet the criteria set by <net_type_condition_list> in order to be a match. The argument <net_type_condition_list>, as well as the matching process, are defined in the same way as in the command perc::commandw.

Similarly, if the optional switch -pathType is specified, a net must meet the criteria set by <path_type_condition_list> in order to be a match. The argument <path_type_condition_list>, as well as the matching process, are defined in the same way as in the command perc::commandx.

If the optional switch -condition is specified, the argument <cond_proc> must be a Tcl proc that takes a net iterator as its only argument. <cond_proc> must return the value of 1 if the net meets its condition, and return the value of 0 otherwise.

When checking a net, if the switch -condition is specified, the programmable electrical rule check tool applies the Tcl proc <cond_proc> to the net. The net is a match only if the return value is 1.

If the optional switch -cell is specified, this command checks the nets locally in each cell. For instance, if a net extends three levels in the hierarchy, this command treats it as three different nets, one in each cell. On the other hand, if -cell is not present, which is the default, this command checks the nets in the flat sense, and produces flat results. When a net goes through several levels of hierarchy, this command accumulates the relevant data from every level of the net, and reports the result once in the cell containing its top-level part.

If the optional switch -comment is specified, the argument <comment> must be a string. The only purpose of <comment> is to annotate the generated results in the report file.

This command can be called at most once in any Tcl proc. If called, it must be the only rule command used in the Tcl proc.

This command returns nothing.

Examples of the use of this command are listed below:

| COMMAND4 test [/* | |
|---|---|
| proc check_1 { } { | |
| perc::commandα | -netType {! Power Ground} \ |
| | -pathType {! Power Ground} \ |
| | -comment “Net has no path to power AND |
| | ground” |
| } | |
| proc path_check {net} { | |
| if {[perc::commandx $net {Power}] == 0 \|\| \ | |
| [perc::commandx $net {Ground}] == 0 } { | |
| return 1 | |
| } | |
| return 0 | |
| } | |
| proc check_2 { } { | |
| perc::commandα | -netType {! Power Ground} \ |
| | -condition path_check \ |
| | -comment “Net has no path to power OR |
| | ground” |
| } | |
| */] | |

Tcl proc check_1 selects nets that have no path to Power and no path to Ground. The Power and Ground nets themselves are excluded from the results.

Tcl proc check_2 selects nets that have no path to Power or no path to Ground (or both). The Power and Ground nets themselves are excluded from the results. Here, the Tcl proc path_check is used to express the OR logical relation, as that is not supported by the -pathType switch.

The Device Rule Check Command:

| | |
|---|---|
| perc::commandβ | [-type <type_list>] |

[-subtype <subtype_list>]
[-property <constraint>]
[-pinNetType <pin_net_type_condition_list>]
[-pinPathType <pin_path_type_condition_list>]
[-condition <cond_proc>]
[-comment <comment>]

This command checks each primitive device in the design to find the ones that match all of the conditions specified by the optional switches. If a device is a match, the programmable electrical rule check tool outputs the device to the report file as a generated result. It should be noted that the default behavior where no switch is provided is not very useful because every device is a match in that case.

If the optional switch -type is specified, a device must have one of the types listed in <type_list> in order to be a match. The argument <type_list> must be a Tcl list consisting of one or more device types.

The optional -subtype switch specifies device models. <subtype_list> must be a Tcl list consisting of one or more device models, and starting with possibly the exclamation symbol (!), such as “model_1 model_2” or “! model_3 model_4”. If the exclamation symbol is not present, then only devices with these models can be a match. However, if the exclamation symbol is specified, then only devices with models other than those listed can be a match.

The optional -property switch specifies a device property condition to further limit the devices that can be a match. <constraint> must be an nonempty string specifying a property name followed by a constraint limiting the value of the property. Only devices satisfying <constraint> can be a match. The notation for <constraint> is the same as that of COMMAND12. Specifically, the following list shows all of the valid expressions for specifying constraints (P is some property name, while a and b are some constants):
P<a
P>a
P<=a
P>=a
P==a
P!=a
P>a<b
P>=a<b
P>a<=b
P>=a<=b

If the optional switch -pinNetType is specified, a device must meet the criteria set by <pin_net_type_condition_list> in order to be a match. The argument <pin_net_type_condition_list> must be a Tcl list consisting of pairs of <pin_name_list> and <net_type_condition_list>, where <pin_name_list> and <net_type_condition_list> are defined as in the command perc::commandu. For example, {{S D} {Power} {G} {Ground} } is a list with two pairs. A device is said to meet the criteria if perc::commandu returns the value of 1 when applied to the device and each pair of <pin_name_list> and <net_type_condition_list>.

If the optional switch -pinPathType is specified, a device must meet the criteria set by <pin_path_type_condition_list> in order to be a match. The argument <pin_path_type_condition_list> must be a Tcl list consisting of pairs of <pin_name_list> and <path_type_condition_list>, where <pin_name_list> and <path_type_condition_list> are defined as in the command perc::commandv. For example, {{S D} {Power} {G} {Ground}} is a list with two pairs. A device is said to meet the criteria if perc::commandv returns the value of 1 when applied to the device and each pair of <pin_name_list> and <path_type_condition_list>.

If the optional switch -condition is specified, the argument <cond_proc> must be a Tcl proc that takes an instance iterator as its only argument. <cond_proc> must return the value of 1 if the device meets its condition, and return the value of 0 otherwise.

When checking a device, if the switch -condition is specified, then the programmable electrical rule check tool applies the Tcl proc <cond_proc> to the device. The device is a match only if the return value is 1.

If the optional switch -comment is specified, the argument <comment> must be a string. The only purpose of <comment> is to annotate the generated results in the report file.

This command can be called at most once in any Tcl proc. If called, it must be the only rule command used in the Tcl proc.

This command returns nothing. Examples of the use of this command are as follows:

```
  COMMAND4 test [/*
    proc check_1 { } {
      perc::commandβ -type {MP MN} \
                  -pinNetType {{S D} {Power} {S D} {Ground}} \
                  -comment “MOS connected to power and ground”
    }
    proc pin_check {instance} {
      if {[perc::commandu $instance {S D} {Power}] == 1 && \
          [perc::commandu $instance {S D} {Ground}] == 1 } {
        return 1
      }
      return 0
    }
    proc check_2 { } {
      perc::commandβ -type {MP MN} \
                  -condition pin_check \
                  -comment “MOS connected to power and ground”
    }
  */]
  COMMAND4 demo [/*
    proc setup { } {
      perc::commanda+ “label_foo” -type {R} -subtype {foo} -pin
{p n} -cell
      perc::commanda+ “label_bar” -type {R} -subtype {bar} -pin
{p n} -cell
      perc::commandc -type {MP MN} -pin {s d}
      perc::commandc -type {R} -subtype { ! foo bar } -pin {p n}
    }
    proc check_3 { } {
      perc::commandβ -type {R} -subtype {foo} \
                  -pinPathType {{P N} {label_bar}} \
                  -comment “R(foo) having a path to R(bar)”
    }
  */]
```

Tcl proc check_1 selects regular MP/MN devices that are directly connected to Power and Ground nets. The pin list {S D} is useful because source/drain pins are swappable. Tcl proc check_2 does the same thing as check_1, but uses the -condition switch instead. Tcl proc check_3 is an example of path check from device to device. It selects resistors of model foo that have a path to resistors of model bar.

The Data Rule Check command:
perc::commandγ-condition <cond_proc> [-comment <comment>]

Unlike the perc::commandα or perc::commandβ commands, this command does not implement an internal algorithm that automatically outputs results to the report file. It basically does nothing by itself.

The required switch -condition specifies the argument <cond_proc> that must be a Tcl proc with no arguments. This command executes <cond_proc> once. So, if any results are to be generated, <cond_proc> has to do all the work.

If the optional switch -comment is specified, the argument <comment> must be a string. The only purpose of <comment> is to annotate the generated results in the report file.

This command can be called at most once in any Tcl proc. If called, it must be the only rule command used in the Tcl proc.

This command returns nothing. Examples of the use of this command are listed below:

```
COMMAND4 test [/*
  proc work_horse { } {
    # The commands used here will be discussed later
    set max [perc::commandθ -param L -type {MP MN}]
    perc::commandδ -title “Found max length:” -value “$max”
  }
  proc check_1 { } {
    perc::commandγ -condition work_horse \
          -comment “Maximum length of MOS devices in the design”
  }
*/]
```

Tcl proc check_1 executes the procedure work_horse, which finds the maximum length of all MOS devices in the design, and writes the result to the report file.

The Adding User Data to the Report File Command:

```
perc::commandδ [-title <title>]
                      [-value <value>]
                      [-list <list>]
```

This command can only be called in the context of a rule check. In other words, at the time this command is invoked, one of the three rule commands must be in progress: perc::commandα, perc::commandβ, or perc::commandγ.

This command formats the data from the arguments into a nice string and writes the string to the report file. If the context is perc::commandα, the data is added to the result of the selected net. If the context is perc::commandβ, the data is added to the result of the selected device. However, if the context is perc::commandγ, then the data is put in the top cell, not associated with any net or device.

If the optional switch -title is specified, the argument <title> must be a string. <title> becomes the first line of the resulting string. If the optional switch -value is specified, the argument <value> must be a string. <value> becomes the second line of the resulting string. If the optional switch -list is specified, the argument <list> must be a Tcl list. Each entry in <list> becomes a line of the resulting string.

This command can be called any number of times in a Tcl proc. All data is written to the report file. This command returns nothing. Examples of the use of this command are listed below:

```
COMMAND4 test [/*
  proc calc_property {instance} {
    set length [perc::commando $instance L]
    set width [perc::commando $instance W]
    if {$length > 5} {
        perc::commandδ -value “Bad length (> 5): $length”
        return 1
    }
    if {$width <2} {
        perc::commandδ -value “Bad width (< 2): $width”
        return 1
    }
    return 0
  }
  proc check_1 { } {
    perc::commandβ -type {MP MN} \
                      -condition calc_property \
                      -comment “MOS with bad properties”
  }
*/]
```

By default, the command perc::commandβ does not write property values to the report file. Here, since the property values are important, the procedure calc_property explicitly adds the property data to the report file. The reported property values will be associated with the selected device in the report file.

The Computing Sum Command:

```
perc::commandε -param <property_or_proc>
          [-net <net_iterator>]
          [-type <type_list>]
          [-subtype <subtype_list>]
          [-property <constraint>]
          [-pinAtNet <pin_name_list>]
          [-pinNetType <pin_net_type_condition_list>]
          [-pinPathType <pin_path_type_condition_list>]
          [-condition <cond_proc>]
          [-list]
```

This command computes the sum of values from a list of devices. The required argument <property_or_proc> specifies the value to be extracted from each device. If the value is a simple property, then <property_or_proc> is just the property name. Otherwise, <property_or_proc> must specify a Tcl proc that takes an instance iterator as the only argument and returns a float number.

The optional switches are used to select the list of devices. A device must meet all of the conditions in order to participate in the computation. If no device is selected, the sum is NaN.

If the optional switch -net is specified, then a device must be connected to the net referenced by <net_iterator> in order to be selected. If -net is not specified, then all devices in the design can be selected. If this command is invoked in the context of perc::perc::commandα or perc::commandβ, then the -net switch must be used.

If the optional switch -type is specified, a device must have one of the types listed in <type_list> in order to be selected. The argument <type_list> must be a Tcl list consisting of one or more device types.

The optional -subtype switch specifies device models. <subtype_list> must be a Tcl list consisting of one or more device models, and starting with possibly the exclamation symbol (!), such as “model_1 model_2” or “! model_3 model_4”. If the exclamation symbol is not present, then only devices with these models can be selected. However, if the exclamation symbol is specified, then only devices with models other than those listed can be selected.

The optional -property switch specifies a device property condition to further limit the devices that can be selected. <constraint> must be a nonempty string specifying a property name followed by a constraint limiting the value of the property. Only devices satisfying <constraint> can be selected. The notation for <constraint> is the same as that of COMMAND12. Specifically, the following list shows all of the valid expressions for specifying constraints (P is some property name, while a and b are some constants):
P<a
P>a
P<=a
P>=a
P==a
P!=a
P>a<b
P>=a<b
P>a<=b
P>=a<=b

The optional switch -pinAtNet can be used only if the -net switch is specified. If -pinAtNet is specified, a device must be connected to the net through one of the pins listed in <pin_name_list> in order to be selected. The argument <pin_name_list> must be a Tcl list consisting of one or more device pin names

If the optional switch -pinNetType is specified, a device must meet the criteria set by <pin_net_type_condition_list> in order to be selected. The argument <pin_net_type_condition_list> must be a Tcl list consisting of pairs of <pin_name_list> and <net_type_condition_list>, where <pin_name_list> and <net_type_condition_list> are defined as in the command perc::commandu. A device is said to meet the criteria if perc::commandu returns the value of 1 when applied to the device and each pair of <pin_name_list> and <net_type_condition_list>. Note that, if -pinAtNet is specified and the pin connected to the net is also in the <pin_name_list>, this pin name is removed from <pin_name_list> when checking the criteria.

If the optional switch -pinPathType is specified, a device must meet the criteria set by <pin_path_type_condition_list> in order to be selected. The argument <pin_path_type_condition_list> must be a Tcl list consisting of pairs of <pin_name_list> and <path_type_condition_list>, where <pin_name_list> and <path_type_condition_list> are defined as in the command perc::commandv. A device is said to meet the criteria if perc::commandv returns the value of 1 when applied to the device and each pair of <pin_name_list> and <path_type_condition_list>. Note that, if -pinAtNet is specified and the pin connected to the net is also in the <pin_name_list>, this pin name is removed from <pin_name_list> when checking the criteria.

If the optional switch -condition is specified, the argument <cond_proc> must be a Tcl proc that takes an instance iterator as its first argument. If -net is not present, then <cond_proc> must take the instance iterator as its only argument. If -net is specified, then <cond_proc> can also take a pin iterator as its optional second argument. <cond_proc> must return the value of 1 if the device meets its condition, and return the value of 0 otherwise.

When selecting a device, if the switch -condition is specified, then the programmable electrical rule check tool applies the Tcl proc <cond_proc> to the device. The device's pin connected to the net is also passed to <cond_proc> if -net is present and <cond_proc> takes the optional second argument. The device is selected only if the return value is 1.

If the optional switch -list is specified, this command keeps the selected devices in a list, and returns the list along with the computed value. Each entry in the list is itself a list of two items: the first item is the hierarchical path of the selected device relative to the current cell placement, and the second item is an iterator pointing to the device. This allows the user to traverse the selected devices if necessary.

This command can be called any number of times in a Tcl proc. It returns a float number (the sum) if -list is not specified, otherwise, it returns the sum and the selected devices as a Tcl list of length two in the form {sum device_list}. Examples of the use of this command are listed below:

```
  COMMAND4 test [/*
    proc wl_ratio {instance} {
      set w [perc::commando $instance W]
      set l [perc::commando $instance L]
      set ratio [expr {$w/$l}]
      return $ratio
    }
    proc calc_sum {net} {
      set sum_a [perc::commandε -param W -net $net -type {MP
MN} - pinAtNet {G}]
      set sum_b [perc::commandε -param wl_ratio -net $net -type
      {MP} \
                          -pinAtNet {S D} -pinNetType {{S D}
{Power}}]
      set pair [perc::commandε -param L -net $net -type {MP MN}
      -list]
      set sum_c [lindex $pair 0]
      set selected_devices [lindex $pair 1]
      if {$sum_a < 40 || $sum_b > 60} {
        return 1
      }
      if {$sum_c < 50} {
        set total_count [llength $selected_devices]
        set mp_count 0
        set mn_count 0
        for {set i 0} {$i < $total_count} {incr i} {
    set dev_pair [lindex $selected_devices $i]
            set dev_itr [lindex $dev_pair 1]
            if { [string equal -nocase [perc::commandm $dev_itr]
            “mp”] }
{
      incr mp_count
            } else {
      incr mn_count
            }
        }
perc::commandδ -title “Bad L sum: $sum_c” \
                -value “Number of MP devices: $mp_count, MN
deivces: $mn_count” \
                -list $selected_devices
            return 1
        }
        return 0
      }
      proc check_1 { } {
        perc::commandα -netType {PAD} \
                        -condition calc_sum \
                        -comment “Net with bad property sum”
      }
  */]
```

Tcl proc check_1 is a net rule check. It first filters out the nets without the net type PAD, then computes three sum values for each remaining net. sum_a is the sum of MOS width from MP/MN devices connected to the net. A device is counted only if the connecting pin is the GATE pin. sum_b is the sum of width/length ratio from MP devices connected to the net. A device is counted only if the connecting pin is the SOURCE or DRAIN pin, and the other pin (S or D) has type Power. Notice the use of Tcl proc wl_ratio, because ratio is not a simple property. For any net having net type PAD, if its sum_a is less than 40 or sum_b is greater than 60, the net is selected and written to the report file. sum_c is the sum of MOS length from MP/MN devices connected to the net. To keep track of the selected devices, -list is specified. As a result, the return value from perc::commandε is a list of length two. If sum_c is less than 50, the net is reported. To add extra data to the report file, the selected devices are traversed, and the MP and MN devices are counted. All of the selected devices are written to the report file via perc::commandδ.

The Computing Product Command:

```
perc::commandζ -param <property_or_proc>
          [-net <net_iterator>]
          [-type <type_list>]
          [-subtype <subtype_list>]
          [-property <constraint>]
          [-pinAtNet <pin_name_list>]
          [-pinNetType <pin_net_type_condition_list>]
          [-pinPathType <pin_path_type_condition_list>]
          [-condition <cond_proc>]
          [-list]
```

This command computes the product of values from a list of devices. The required argument <property_or_proc> specifies the value to be extracted from each device. If the value is a simple property, then <property_or_proc> is just the property name. Otherwise, <property_or_proc> must specify a Tcl proc that takes an instance iterator as the only argument and returns a float number.

The optional switches are used to select the list of devices. A device must meet all of the conditions in order to participate in the computation. The optional switches -net, -type, -subtype, -property, -pinAtNet, -pinNetType, -pinPathType, -list, and -condition are defined in the same way as in perc::commandε. If no device is selected, the product is NaN.

This command can be called any number of times in a Tcl proc. It returns a float number (the product) if -list is not specified, otherwise, it returns the product and the selected devices as a Tcl list of length two in the form {product device_list}. Examples of the use of this command are listed below:

```
COMMAND4 test [/*
  proc calc_prod {net} {
    set product [perc::commandζ -param R -net $net -type {R}]
    if {$product > 500} {
      return 1
    }
    return 0
  }
  proc check_1 { } {
    perc::perc::commandα -condition calc_prod \
                  -comment “Net with bad property product”
  }
*/]
```

Tcl proc check_1 is a net rule check. For each net, it computes the product of resistance from all resistors connected to the net. If the product is greater than 500, the net is selected and written to the report file.

The Computing Minimum Command:

```
perc::commandη -param <property_or_proc>
          [-net <net_iterator>]
          [-type <type_list>]
          [-subtype <subtype_list>]
          [-property <constraint>]
          [-pinAtNet <pin_name_list>]
          [-pinNetType <pin_net_type_condition_list>]
          [-pinPathType <pin_path_type_condition_list>]
          [-condition <cond_proc>]
          [-list]
```

This command computes the minimum of values from a list of devices. The required argument <property_or_proc> specifies the value to be extracted from each device. If the value is a simple property, then <property_or_proc> is just the property name. Otherwise, <property_or_proc> must specify a Tcl proc that takes an instance iterator as the only argument and returns a float number.

The optional switches are used to select the list of devices. A device must meet all of the conditions in order to participate in the computation. The optional switches -net, -type, -subtype, -property, -pinAtNet, -pinNetType, -pinPathType, -list, and -condition are defined in the same way as in perc::commandc. If no device is selected, the minimum is NaN. If the optional switch -list is specified, the returned selected devices are the devices having the minimum value.

This command can be called any number of times in a Tcl proc. It returns a float number (the minimum) if -list is not specified, otherwise, it returns the minimum and the devices having the minimum value as a Tcl list of length two in the form {minimum device_list}. Examples of the use of this command are listed below:

```
COMMAND4 test [/*
  proc calc_min {net} {
    set result [perc::commandη -param R -net $net -type {R} -list]
    set min_value [lindex $result 0]
    set min_devices [lindex $result 1]
    if {$min_value > 200} {
      perc::commandδ -value “Bad min resistance: $min_value” \
                              -list $min_devices
      return 1
    }
    return 0
  }
  proc check_1 { } {
    perc::commandα -condition calc_min \
                    -comment “Net with bad minimum property”
  }
*/]
```

Tcl proc check_1 is a net rule check. For each net, it computes the minimum resistance from all resistors connected to the net. If the minimum is greater than 200, the net is selected and written to the report file. In addition, it outputs the minimum value and the list of resistors having the minimum resistance to the report file.

The Computing Maximum Command:

```
perc::commandθ -param <property_or_proc>
          [-net <net_iterator>]
          [-type <type_list>]
          [-subtype <subtype_list>]
          [-property <constraint>]
          [-pinAtNet <pin_name_list>]
          [-pinNetType <pin_net_type_condition_list>]
          [-pinPathType <pin_path_type_condition_list>]
          [-condition <cond_proc>]
          [-list]
```

This command computes the maximum of values from a list of devices. The required argument <property_or_proc> specifies the value to be extracted from each device. If the value is a simple property, then <property_or_proc> is just the property name. Otherwise, <property_or_proc> must specify a Tcl proc that takes an instance iterator as the only argument and returns a float number.

The optional switches are used to select the list of devices. A device must meet all of the conditions in order to participate in the computation. The optional switches -net, -type, -subtype, -property, -pinAtNet, -pinNetType, -pinPathType, -list, and -condition are defined in the same way as in perc::commandc. If no device is selected, the maximum is NaN. If the optional switch -list is specified, the returned selected devices are the devices having the maximum value.

This command can be called any number of times in a Tcl proc. It returns a float number (the maximum) if -list is not specified, otherwise, it returns the maximum and the devices having the maximum value as a Tcl list of length two in the form {maximum device_list}.

Examples of the use of this command are listed below:

```
COMMAND4 test [/*
  proc calc_max {net} {
    set result [perc::commandθ -param R -net $net -type {R} -list]
    set max_value [lindex $result 0]
    set max_devices [lindex $result 1]
    if {$max_value < 50} {
      perc::commandδ -value “Bad max resistance: $max_value” \
                            -list $max_devices
      return 1
    }
    return 0
  }
  proc check_1 { } {
    perc::commandα -condition calc_max \
                    -comment “Net with bad maximum property”
  }
*/]
```

Tcl proc check_1 is a net rule check. For each net, it computes the maximum resistance from all resistors connected to the net. If the maximum is less than 50, the net is selected and written to the report file. In addition, it outputs the maximum value and the list of resistors having the maximum resistance to the report file.

The Computing Device Count Command:

perc::commandι [-net <net_iterator>]

[-type <type_list>]
[-subtype <subtype_list>]
[-property <constraint>]
[-pinAtNet <pin_name_list>]
[-pinNetType <pin_net_type_condition_list>]
[-pinPathType <pin_path_type_condition_list>]
[-condition <cond_proc>]
[-list]

This command computes the count of a list of devices. The optional switches are used to select the list of devices. A device must meet all of the conditions in order to participate in the computation. The optional switches -net, -type, -subtype, -property, -pinAtNet, -pinNetType, -pinPathType, -list, and -condition are defined in the same way as in perc::commandε. If no device is selected, the count is 0.

This command can be called any number of times in a Tcl proc. It returns an integer number (the count) if -list is not specified, otherwise, it returns the count and the selected devices as a Tcl list of length two in the form {count device_list}. Examples of the use of this command are listed below:

```
COMMAND4 test [/*
  proc calc_count {net} {
    set number_of_devices [perc::commandι -net $net]
    if {$number_of_devices == 0} {
      return 1
    }
    return 0
  }
  proc check_1 { } {
    perc::commandα -condition calc_count \
                    -comment “Net with no devices”
  }
*/]
```

Tcl proc check_1 is a net rule check. For each net, it computes the number of devices connected to the net. If no device is found, the net is selected and written to the report file.

The Computing Adjacent Net or Path Count Command:

```
  perc::commandκ
              -net <net_iterator>
              {-adjacentPinNetType
              <adjacent_pin_net_type_condition>
|
              -adjacentPinPathType
  <adjacent_pin_path_type_condition>}
            [-type <type_list>]
            [-subtype <subtype_list>]
            [-property <constraint>]
            [-pinAtNet <pin_name_list>]
            [-pinNetType <pin_net_type_condition_list>]
            [-pinPathType <pin_path_type_condition_list>]
            [-condition <cond_proc>]
            [-list]
```

The net pointed to by the required argument <net_iterator> is the base net. The base net is connected to a list of devices. Any net other than the base net that is connected to at least one device in this list is called an adjacent net of the base net. This command counts the number of adjacent nets or paths that satisfy the conditions specified by its arguments.

The optional switches are used to select the list of devices. A device must meet all of the conditions in order to participate in the computation. The optional switches -type, -subtype, -property, -pinAtNet, -pinNetType, -pinPathType, -list, and -condition are defined in the same way as in perc::commandε. If no device is selected, the count is 0.

Only one of the two switches can be used: -adjacentPinNetType or -adjacentPinPathType. If -adjacentPinNetType is specified, then an adjacent net must meet the criteria set by <adjacent_pin_net_type_condition> in order to be counted. The required argument <adjacent_pin_net_type_condition> must be a Tcl list consisting of one pair of <pin_name_list> and <net_type_condition_list>, where <pin_name_list> and <net_type_condition_list> are defined as in the command perc::commandu. An adjacent net is said to meet the criteria if perc::commandu returns the value of 1 when applied to the net's connected device, <pin_name_list> and <net_type_condition_list>. Note that for this device, if -pinAtNet is specified and its pin connected to the base net is also in the <pin_name_list>, this pin name is removed from <pin_name_list> when checking the criteria.

The command counts the unique adjacent nets in the flat sense. Also, it only returns three values:
0—no adjacent net is found
1—one adjacent net is found
2—more than one unique adjacent nets are found

On the other hand, if -adjacentPinPathType is specified, an adjacent net must meet the criteria set by <adjacent_pin_path_type_condition> in order to be counted. The required argument <adjacent_pin_path_type_condition> must be a Tcl list consisting of one pair of <pin_name_list> and <path_type_condition_list>, where <pin_name_list> and <path_type_condition_list> are defined as in the command perc::commandv. An adjacent net is said to meet the criteria if perc::commandv returns the value of 1 when applied to the net's connected device, <pin_name_list> and <path_type_condition_list>. Note that for this device, if -pinAtNet is specified and its pin connected to the base net is also in the <pin_name_list>, this pin name is removed from <pin_name_list> when checking the criteria.

In this case, the command counts the adjacent paths, not the adjacent nets. An adjacent path is a path that contains an adjacent net. Also, the command counts the unique adjacent paths in the flat sense, and it only returns three values:
0—no adjacent path is found
1—one adjacent path is found
2—more than one unique adjacent paths are found

In both cases, if the optional switch -list is specified, this command keeps a list of the devices that contributed the selected adjacent nets or paths, and returns the list along with the count.

This command can be called any number of times in a Tcl proc. It returns an integer number (the count) if -list is not specified, otherwise, it returns the count and the selected devices as a Tcl list of length two in the form {count device_list}. Examples of the use of this command are listed below:

```
COMMAND4 test [/*
  proc calc_adjacent_net {net} {
    set count [perc::commandκ -net $net \
                  -adjacentPinNetType {{S D} {PAD}} \
                  -type {MP MN} -pinAtNet {S D} ]
    if {$count > 1} {
      return 1
    }
    return 0
  }
  proc check_1 { } {
    perc::commandα -condition calc_adjacent_net \
      -comment “Net with MOS devices connected to different PAD
nets”
  }
  proc calc_adjacent_path {net} {
    set count [perc::commandκ -net $net \
                  -adjacentPinPathType {{S D} {PAD}} \
                  -type {MP MN} -pinAtNet {S D} ]
    if {$count > 1} {
      return 1
    }
    return 0
  }
  proc check_2 { } {
    perc::commandα -condition calc_adjacent_path \
      -comment “Net with MOS devices connected to different PAD
paths”
  }
*/]
```

Tcl proc check_1 is a net rule check. For each base net, it first filters out the devices that are not MP/MN or not connected to the base net at the source/drain pin. Then it checks the nets at the other end of source/drain for the remaining devices. Of those nets, any net that has the net type PAD is qualified. If the number of qualified adjacent nets is greater than 1, the base net is selected and written to the report file.

Tcl proc check_2 is also a net rule check. For each base net, it first filters out the devices that are not MP/MN or not connected to the base net at the source/drain pin. Then it checks the nets at the other end of source/drain for the remaining devices. Of those nets, any net whose path has the net type PAD is qualified. If the number of paths containing these qualified adjacent nets is greater than 1, the base net is selected and written to the report file.

As mentioned in section 6.1, without specifying the optional -cell switch, the command perc::commandα produces flat results. However, its implementation is hierarchical using a bottom-up algorithm. Basically, for any net that extends several levels of hierarchy, the programmable electrical rule check tool checks each level of the net separately in their respective cell, accumulates the partial data, and finally combines the result in the cell that contains the top-level part of the net. Therefore, the user code for net rule checking must ensure that the data gathering part is unconditional.

Examples of the use of this command are listed below:

```
COMMAND4 test [/*
  proc calc_1 {net} {
    set sum [perc::commandε -param W -net $net -type {MP MN}]
    set min [perc::commandη -param L -net $net -type {MP MN}]
    if {$sum <= 20 && $min > 30} {
      return 1
    }
    return 0
  }
  proc check_1 { } {
    perc::commandα -netType {PAD} \
                    -condition calc_1 \
                    -comment “Net with bad properties”
  }
  proc calc_2 {net} {
    set sum [perc::commandε -param W -net $net -type {MP MN}]
    if {$sum <= 20} {
      set min [perc::commandη -param L -net $net -type {MP MN}]
      if {$min > 30} {
        return 1
      }
    }
    return 0
  }
  proc check_2 { } {
    perc::commandα -netType {PAD} \
                    -condition calc_2 \
                    -comment “Net with bad properties”
  }
*/]
```

Tcl procs check_1 and check_2 appear to be the same, but they are not. Tcl proc calc_1 is correct, because it gathers the relevant data for all nets. Tcl proc calc_2 is wrong. For instance, if CELL_A contains CELL_B, and net A in CELL_A is connected to net B inside CELL_B. If the programmable electrical rule check tool is employing a bottom-up algorithm, net B is examined first. If net B's sum value is greater than 20, then net B's min value is not calculated. At the time when net A is checked, net A's min value is not accurate because net A does not have the data from its lower-level part net B.

On the other hand, if -cell is specified when calling perc::commandα, then the above coding restriction does not apply. In this case, every net is checked and reported separately within each cell. In other words, the programmable electrical rule check tool treats a net extending several levels of hierarchy as several unrelated nets, one for each level. From the implementation point of view, the programmable electrical rule check tool simply ignores the sub-cell instances in each cell when it performs the bottom-up algorithm.

Also, this coding restriction does not apply to other rule checking commands either: perc::commandβ or perc::commandγ. Same as with the perc::commandα-cell, the net-based vector commands invoked in this context compute data for each net separately within each cell.

It should be noted that the command perc::commandβ examines the devices one at a time. To check topology or device grouping conditions, the rule check has to use iterators to traverse the netlist. A common approach is to choose a net essential to the target device grouping configuration, use perc::commandα to get to that net as the starting point, then traverse the neighboring elements of the net in the -condition proc of perc::commandα. For instance, to find inverters whose output is connected to a resistor, the two transistors as a group should be checked.

Examples of the use of this command are listed below:

```
  COMMAND4 test [/*
    proc cond_1 {net} {
      set pair [perc::commandι -net $net -type {MP MN}
      -pinAtNet {s d}
\
                          -pinNetType {{s d} {Supply}} -list]
      set mos_count [lindex $pair 0]
      set mos_devices [lindex $pair 1]
      if {$mos_count != 2} {
        # this net is not connected to one MP and one MN device, bail
out
        return 0
      }
      set res_count [perc::commandι -net $net -type {R} -pinAtNet {p
n}]
      if {$res_count == 0} {
        # this net is not connected to a resistor, bail out
        return 0
      }
      # This net is a potential target. Now check the remaining
conditions
      # of the inverter configurations: one device is MP, the other is
MN,
      # and their gate pins are connected to the same net.
      set mp_gate_net_itr “”
      set mn_gate_net_itr “”
      # Loop the mos_devices list which contains device iterators
      for {set i 0} {$i < $mos_count} {incr i} {
        set mos_pair [lindex $mos_devices $i]
        set mos_itr [lindex $mos_pair 1]
        if { [string equal -nocase [perc::commandm $mos_itr] “mp”]
&& \
            [perc::commandu $mos_itr {s d} {Power}] } {
          # this is a MP device connected to Power, get its gate pin
          set gate_pin_itr [perc::commandh$mos_itr -name “g”]
          set mp_gate_net_itr [perc::commandf $gate_pin_itr]
        } elseif { [string equal -nocase [perc::commandm $mos_itr]
“mn”] && \
            [perc::commandu $mos_itr {s d} {Ground}] } {
          # this is a MN device connected to Ground, get its gate pin
          set gate_pin_itr [perc::commandh$mos_itr -name “g”]
          set mn_gate_net_itr [perc::commandf $gate_pin_itr]
        }
      }
      if { $mp_gate_net_itr ne “” && $mn_gate_net_itr ne “” } {
        # Found both MP and MN, now Compare the net iterators
        if { $mp_gate_net_itr eq $mn_gate_net_itr } {
          # The gate pins are connected to the same net.
          # So all conditions are met. Report it.
          return 1
        }
      }
      return 0
    }
    proc check_1 { } {
      perc::commandα -condition cond_1 -netType { ! Supply } -cell \
                      -comment “Inverter's output net connected to a
resistor”
    }
  */]
```

Tcl proc cond_1 uses pin and net iterators for traversing and comparison. As mentioned above, iterators only exist in the context of a cell placement. Therefore, device grouping rule checks produce correct results only if all related devices are contained in the same cell. In other words, if a netlist has device groups that cross cell boundaries, then those cells cannot serve as hcells in order to check the device groupings.

Since inverters are assumed to reside in each hcell, Tcl proc check_1 specifies the -cell switch to instruct the perc::commandα command to check every net separately within each cell.

### Result Reports

The programmable electrical rule check tool report may be an ASCII file that contains the complete results of a programmable electrical rule check tool run. With various implementations of a programmable electrical rule check tool according to various embodiments of the invention, the report may include:
LVS netlist compiler errors and warnings, if any were found.
PERC header section, specifying the report file name, either the layout or the source design name (depending on which one is chosen), the rule file name, the rule file title, the external hcell file name (if specified), the time and date when the report was created, the current working directory, user name, Calibre version and other information.
OVERALL VERIFICATION RESULTS section. It includes the primary status message, secondary status messages, result count, a cell summary listing the primary status and result count for each cell, a rule check summary listing the status and result count for each rule check, a list of errors, if any, found during initialization and rule checking, and finally, a LVS PARAMETERS section showing the LVS settings used.
Cell-by-cell verification results. Each hcell is represented with a section of its own, titled CELL VERIFICATION RESULTS.

The overall primary verification status may have three values. They are:
COMPLETED with NONEMPTY RESULTS, if all individual rule checks are successfully completed, and at least one rule check produces results.
COMPLETED with EMPTY RESULTS, if all individual rule checks are successfully completed, and no rule check produces results.
FAILED, if the input data has problems, or LVS operations have problems, or at least one rule check is skipped or failed.

There are a number of secondary status messages that present additional information on the nature of failures. The following is a list of programmable electrical rule check tool specific ones:
Error: Not all RuleChecks finished.
Indicates that some rule checks are aborted with runtime errors.
Error: Not all RuleChecks executed.
Indicates that some rule checks are skipped due to initialization problems.
Error: Not all InitProcedures finished.
Indicates that some initialization procedures of COMMAND5 statements are aborted with runtime errors.

Other secondary status messages are used to describe failures of layout-versus-schematic (LVS) verification tool operations, and are the same as in the layout-versus-schematic (LVS) verification tool report, such as “Error: Property ratio errors in split gates”.

The rule check status may have three values. They are:
COMPLETED, if the rule check is successfully completed, with or without producing results.
FAILED, if the rule check is executed, but aborted with errors.
SKIPPED, if the rule check is not run due to COMMAND5 initialization problems.

During COMMAND5 initialization or rule checking, the programmable electrical rule check tool executes Tcl procs. The programmable electrical rule check tool captures runtime problems as Tcl errors, and subsequently reports them in the TVF ERROR section. The following is a list of the errors:
ERROR: cannot call rule check commands during initialization.
This error is issued if any rule check command is called in initialization procedures of COMMAND5 statements.
ERROR: cannot call initialization commands outside an init proc.
This error is issued if any initialization command is called in rule checks.
ERROR: cannot call perc::commandδ outside of rule checking commands:
   perc::commandα, perc::commandβ, or perc::commandγ.
This error is issued if perc::commandδ is called at the time when none of the rule checking commands is in progress.
ERROR: more than one rule commands are called in the rule check.
   Only one is allowed.
This error is issued if two or more rule check commands are called in a single rule check.
ERROR: too many PERC net types are defined. The maximum allowed is 64.
This error is issued if the number of net types defined in a single initialization procedure exceeds 64.
ERROR: too many PERC net type sets are defined. The maximum allowed is 64.
This error is issued if the number of net type sets defined in a single initialization procedure exceeds 64.
ERROR: the same name is used to define a net type and a net type set: <name>.
This error is issued if a net type shares a name with a type set in a single initialization procedure.
ERROR: more than one -cell and/or -cellName arguments are specified for
   net type: <type>. Only one is allowed.
This error is issued if the command perc::commanda or perc::commanda+ is called two or more times for the same net type, with the -cell or -cellName switch in a single initialization procedure.
ERROR: invalid net type or type set name: <name>.
This error is issued if the named net type or type set is referenced but not defined.
ERROR: invalid -pin argument in calling perc::commandc, need at least two pins.
This error is issued if there are not enough pins to establish a path across a device.
ERROR: more than one -break conditions are specified in creating net paths. Only one is allowed.
This error is issued if the command perc::commandc is called two or more times with the -break switch in a single initialization procedure.
ERROR: invalid -exclude switch, it is allowed only when -break is present.
This error is issued if the command perc::commandc is called with the -exclude switch, but without the -break switch.
ERROR: property constraint contains invalid <token>.
This error is issued if the -property argument is not a string conforming to the constraint syntax.
ERROR: invalid pin <name> for device type <type>.
This error is issued if devices of the specified type do not have the named pin.
ERROR: unknown argument in calling <command>: <arg>
This error is issued if a command argument is not recognized.
ERROR: missing argument in calling <command>: <arg>
This error is issued if a required command argument is not provided.
ERROR: wrong arguments in calling <command>.
This error is issued if a command is called with incorrect syntax or some argument values are invalid.
ERROR: device type is an empty string.
This error is issued if the empty string is specified as a device type.
ERROR: duplicate names in <some> list: <name>.
This error is issued if the same name is specified twice in any list used as an argument to any PERC command.
ERROR: <some> list is empty.
This error is issued if any list used as an argument to any PERC command is empty.
ERROR: cannot find property <name> for device <device name>.
This error is issued if the named device property is referenced but cannot be found, either because it is missing in the input netlist, or because it is not loaded by COMMAND3 statements.
ERROR: invalid -pinNetType argument. It must be a list of pairs:
   {<pin_name_list> <net_type_list> . . . }”
This error is issued if the -pinNetType argument is not a list consisting of even number of items.
ERROR: invalid -pinPathType argument. It must be a list of pairs:
   {<pin_name_list> <net_type_list> . . . }
This error is issued if the -pinPathType argument is not a list consisting of even number of items.
ERROR: invalid -pinAtNet switch, it is allowed only when -net is present.
This error is issued if a vector command is called with the -pinAtNet switch, but without the -net switch.
ERROR: wrong -adjacentPinNetType argument. It has to be a pair:
   {<pin_name_list> <net_type_list>}.
This error is issued if the -adjacentPinNetType argument is not a list consisting of two items.
ERROR: wrong -adjacentPinPathType argument. It has to be a pair:
   {<pin_name_list> <net_type_list>}.
This error is issued if the -adjacentPinPathType argument is not a list consisting of two items.
ERROR: invalid -adjacentPinNetType or -adjacentPinPathType argument in
   calling perc::commandκ, one and only one must be specified.
This error is issued if neither -adjacentPinPathType nor -adjacentPinPathType is specified, or both are specified.
ERROR: cannot increment a single element iterator.
This error is issued if the argument to perc::commandk is an iterator pointing to a single element.
ERROR: invalid <kind> iterator.
This error is issued if the argument to a PERC command is not the right iterator as expected. This happens if the argument value is not an iterator at all, or it is the different kind of iterator, for instance, a pin iterator when a net iterator is expected, or it is the right kind of iterator, but it has reached the end, i.e., its string representation is the empty string.
ERROR: cannot descend from the non-hcell instance: <name>.
This error is issued if the argument to perc::commandj is not an instance iterator pointing to a sub-cell instance, or a pin iterator pointing to a pin of a sub-cell instance.

Each hcell is represented with a section of its own, titled CELL VERIFICATION RESULTS. First, it includes a primary status. The cell primary status may have three values. They are:
COMPLETED with NONEMPTY RESULTS, if at least one rule check produces results within the cell.
COMPLETED with EMPTY RESULTS, if no rule check produces results within the cell.
FAILED, if the input data has problems, or LVS operations have problems for the cell.

Optionally, it also includes any number of secondary status messages that describe failures of LVS operations for the cell. They are the same as in the LVS report, such as “Error: Property ratio errors in split gates”.

Next, the numbers of ports, nets, and instances per component type are shown. If netlist transformation is performed, the port, net, instance numbers are shown both for the original circuits (INITIAL NUMBERS OF OBJECTS) and for the new modified circuits (NUMBERS OF OBJECTS AFTER TRANSFORMATION). The format is similar to that of the LVS report.

Next, the rule check results for the cell are shown. The results are sorted and listed in groups, with one group for each placement representative. Within each placement group, the results are further divided and listed in subgroups, with one subgroup for each COMMAND5 statement. Within each subgroup, the results are listed for each rule check, in the order as they appear in the COMMAND5 statement.

Optionally, it also includes an INFORMATION AND WARNINGS sub-section that provides additional data about layout-versus-schematic (LVS) verification tool operations, such as Statistics. The format is similar to that of a conventional layout-versus-schematic (LVS) verification tool report.

Each result is identified by a serial result number. A net result starts with the keyword Net, followed by the net name. If the net has net types, they are listed in square brackets. If the net's path types are not equal to its net types, the path types are listed in a second pair of square brackets.

A device result starts with the device name, with its X-Y location if available, followed by its device type and optional subtype in square brackets. It includes the list of pins. Each pin is identified by its name, followed by a ‘:’, followed by the connecting net name, followed by the optional net types and path types.

If the device is a logic gate, then there is no device name. Instead, it is identified by its type in parentheses, followed by a list of transistors forming the gate. Likewise, if the device is an injected component, there is no device name either. It is identified by its type in parentheses, followed by a list of individual devices forming the injected component.

As will be appreciated from the foregoing description, programmable electrical rule check techniques according to various implementations of the invention may provide a set of commands that will allow a user to identify a wide variety of circuit element configurations, using both logical and physical layout data, as desired by the user. Some implementations of the invention may provide both low-level commands, which may be used to identify circuit elements with specific characteristics, and high level commands that use information obtained through the low-level commands to identify specified circuit element configurations.

Further, with some implementations of the invention, one or more of the commands may generate state data describing a set of the identified circuit elements having the specified characteristics. For example, a first low-level command may create a set of data identifying all transistors having a pin (e.g., a drain pin) connected to a digital power source. A second low-level command may create another set of data identifying all transistors having a pin (e.g., a source pin) connected to an analog ground. This state data can then be used by yet another command to identify specified circuit element configurations. For example, a third command, such as a high-level command, can identify transistors common to both sets of state data, and provide, e.g., the names of the common transistors as output to a user.

As also discussed above, various embodiments of the invention may provide a programmable electrical rule check tool that operates natively on hierarchical integrated circuit design data. By operating on data in a hierarchical organization, implementations of a programmable electrical rule check tool according to various embodiments of the invention may analyze circuit design data faster and more efficiently than other conventional electrical rule checking techniques.

It should be appreciated that a programmable electrical rule check tool according to various embodiments of the invention may be implemented by a computer-readable medium storing computer-executable instructions for instruction a computer to perform one or more programmable electrical rule checks as described above, the execution of such instructions, or by a programmable programmed to execute such instructions.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

Thus, in addition to use with “design-for-manufacture” processes, various examples of the invention can be employed with “design-for-yield” (DFY) electronic design automation processes, “yield assistance” electronic design automation processes, “lithographic-friendly-design” (LFD) electronic design automation processes, including “chip cleaning” and “design cleaning” electronic design automation processes, etc. Likewise, in addition to use with “design-rule-check” electronic design automation processes, various implementations of the invention may be employed with “physical verification” electronic design automation processes. Also, in addition to being used with OPC and ORC electronic design automation processes, various implementations of the invention may be used with any type of resolution enhancement electronic design automation processes.

1. (canceled)

2. A method of analyzing integrated circuit design data, comprising
executing one or more low-level commands to obtain state information identifying circuit elements in integrated circuit design data having specified characteristics, and
executing one or more high-level commands to identify specified circuit element configurations using the state data.

3. The method recited in claim 2, wherein the state data includes logical information, physical layout information, or a combination thereof.

4. A computer-readable medium comprising computer-readable instructions for instructing a computer to perform the steps comprising:
conducting an electrical programmable electrical rule check on integrated circuit design data according to a hierarchical organization of the integrated circuit design data.

5. A computer-readable medium comprising computer-readable instructions for instructing a computer to perform the steps comprising:
executing one or more low-level commands to obtain state information identifying circuit elements in integrated circuit design data having specified characteristics, and
executing one or more high-level commands to identify specified circuit element configurations using the state data.

6. (canceled)

7. (canceled)

8. (canceled)
